(19) United States
(12) Patent Application Publication
(10) Pub. No.: US 2020/0258392 A1
(43) Pub. Date: Aug. 13, 2020

(54) NAVIGATION TECHNIQUES FOR AUTONOMOUS AND SEMI-AUTONOMOUS VEHICLES

(71) Applicant: QUALCOMM Incorporated, San Diego, CA (US)

(72) Inventors: Haim Mendel WEISSMAN, Haifa (IL); Arik MIMRAN, Haifa (IL)

(21) Appl. No.: 16/843,035

(22) Filed: Apr. 8, 2020

Related U.S. Application Data
(63) Continuation of application No. 15/706,447, filed on Sep. 15, 2017.
Application No. 15/706,447 is a continuation-in-part of application No. 15/704,883, filed on Sep. 14, 2017, now Pat. No. 10,656,263.

(51) Int. Cl. G08G 1/16; G01C 21/36; G05D 1/02; G01S 19/42; G06K 9/00; G08G 1/00; G01S 13/931; G01S 13/75; G01S 7/41; G01S 13/87; G01S 7/48; G01C 21/28; G01S 13/34; G01S 13/86

(52) U.S. Cl. CPC G08G 1/167; G01S 17/931; G05D 1/0276; G08G 1/164; G01S 19/42; G06K 9/00798; G08G 1/00; G01S 13/931; G01S 13/756; G01S 7/412; G01S 13/758; G01S 13/876; G01S 7/4802; G01C 21/28; G01S 13/34; G01S 13/865; G06T 2207/30256; G01C 21/3658

(57) ABSTRACT

Techniques for operating a self-driving or driver-assist vehicle or other autonomous or semi-autonomous machines are provided. A method according to these techniques includes transmitting a first signal, via an ultra-high frequency (UHF) band, to one or more markers; receiving return signals, at a radar transceiver via a second frequency range different from the UHF band, from the one or more markers; and determining one or more estimate locations of the navigation system based on the return signals.

### CROSS-REFERENCE TO RELATED APPLICATIONS

This application claims priority to and the benefit of U.S. patent application Ser. No. 15/704,883, entitled “EXTENDED LOCALIZATION RANGE AND ASSET TRACKING,” filed on Sep. 14, 2017, which is assigned to the assignee hereof and incorporated by reference; and U.S. patent application Ser. No. 15/706,447, entitled “NAVIGATION TECHNIQUES FOR AUTONOMOUS AND SEMI-AUTONOMOUS VEHICLES,” filed on Sep. 15, 2017, which is assigned to the assignee hereof and incorporated by reference.

### BACKGROUND

Self-driving vehicles are vehicles that are capable of sensing the environment around the vehicle and navigating the vehicle without input from a human driver. Improvements in sensor and control technology have led to significant advances in autonomous vehicle technology. However, conventional solutions to autonomous vehicle navigation often require significant and expensive improvements in the roads and the surrounding infrastructure to enable autonomous vehicles to determine their location and to safely navigate the road system. There are many challenges to safely implementing autonomous driving vehicles as the roadways are designed for manually operated vehicle and are not designed with autonomous traffic mind. Huge investments infrastructure would be required to fully replace and/or upgrade existing roadways to facilitate autonomous vehicle traffic.

### SUMMARY

An example method for operating a navigation system. The navigation system is a navigation system of an autonomous or semi-autonomous vehicle. A method according to these techniques includes transmitting a first signal, via an ultra-high frequency (UHF) band, to one or more markers; receiving return signals, at a radar transceiver via a second frequency range different from the UHF band, from the one or more markers; and determining one or more estimate locations of the navigation system based on the return signals.

An example navigation system for a vehicle according to the disclosure includes means for transmitting a first signal, via an ultra-high frequency (UHF) band, to one or more markers; receiving return signals, at a radar transceiver via a second frequency range different from the UHF band, from the one or more markers; and determining one or more estimate locations of the navigation system based on the return signals.

An example navigation system for a vehicle comprises a radar transceiver, an ultra-high frequency (UHF) transmitter configured to transmit a first signal, via the UHF band, to one or more markers. The navigation system comprises a memory and a processor communicatively coupled to the memory, the UHF transmitter and the radar transceiver, the processor configured to receive return signals, at the radar transceiver via a second frequency range different from the UHF band, from the one or more markers; and determine one or more estimated locations of the navigation system based on the return signals.

An example non-transitory, computer-readable medium according to the disclosure has stored thereon computer-readable instructions for operating a navigation system of a vehicle. The instructions stored thereon cause the navigation system to transmit a first signal, via an ultra-high frequency (UHF) band, to one or more markers; receive, at a radar transceiver via a second frequency range different from the UHF band, return signals from the one or more markers; and determine one or more estimated locations of the navigation system based on the return signals.

### BRIEF DESCRIPTION OF THE DRAWING

FIG. 1 is a schematic diagram of an example operating environment that includes a mobile wireless device in communication with one or more wireless nodes, in accordance with certain example implementations.

FIG. 2 is a functional block diagram of an example computing device that can be used to implement the navigational and driving control systems of the vehicle illustrated in FIG. 1.

FIG. 3 is a is a functional block diagram of an example radar transceiver that can be used to implement the radar transceiver of the vehicle illustrated in FIG. 1 and the radar transceiver illustrated in FIG. 2 modified with receive path (besides the regular radar receive path) to allow processing the backscatter RFID-MMID signals.

FIG. 4 is a is a functional block diagram of an example RFID tag that can be used to implement tags that can be used to implement the techniques disclosed herein, such as the illustrated in FIG. 1.

FIG. 5 is a is a functional block diagram of an example RFID tag that can be used to implement tags that can be used to implement the techniques disclosed herein, such as the markers illustrated in FIG. 1.

FIGS. 6A, 6B, 6C, 6D, and 6E illustrate another example data processing and localization technique according to the disclosure.

FIGS. 7A and 7B are flow diagrams of example processes for navigation according to the disclosure.

FIG. 8 is a flow diagram of an example process for navigation according to the disclosure.

FIG. 9 is a flow diagram of an example process for navigation according to the disclosure.

FIG. 10 is a flow diagram of an example process for navigation according to the disclosure.

FIG. 11 is a flow diagram of an example process for navigation according to the disclosure.

FIG. 12 is a flow diagram of an example process for navigation according to the disclosure.

FIG. 13 is a flow diagram of an example process for navigation according to the disclosure.

FIG. 14 is a flow diagram of an example process for navigation according to the disclosure.

FIG. 15 is a flow diagram of an example process for navigation according to the disclosure.

FIG. 16 is a flow diagram of an example process for navigation according to the disclosure.

FIGS. 17A, 17B, and 17C illustrate another example data processing and localization technique according to the disclosure.

FIGS. 18A and 18B illustrate example markers according to the disclosure.

Like reference symbols in the various drawings indicate like elements, in accordance with certain example implementations.

### DETAILED DESCRIPTION

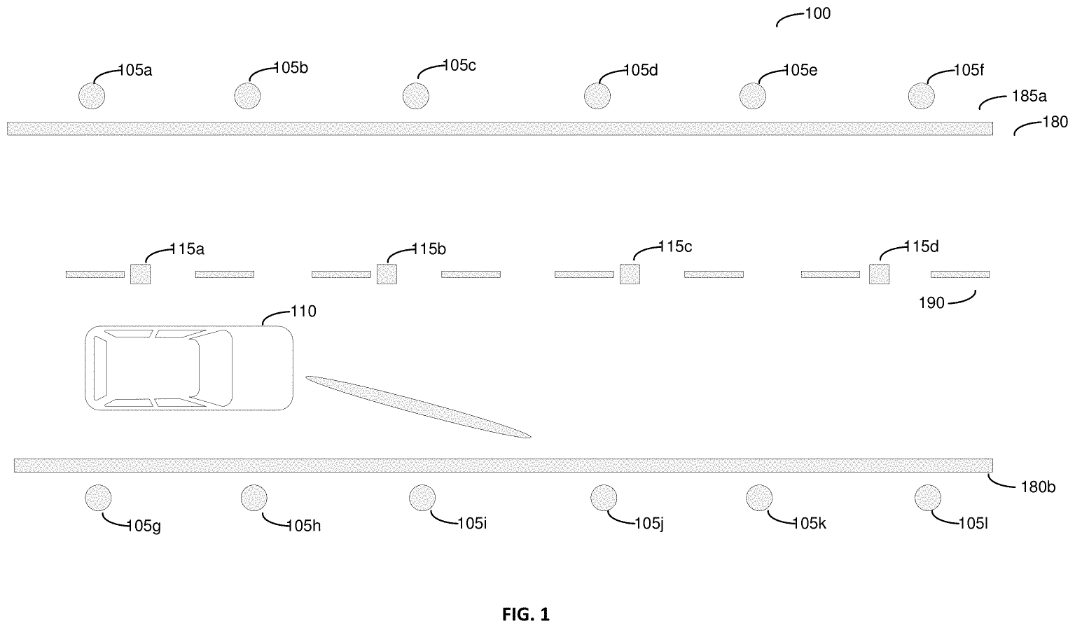

Techniques for navigating a vehicle are provided. The techniques disclosed herein can be used with self-driving vehicles which are configured to autonomously navigate without driver intervention and with semi-autonomous vehicles which are configured such that a driver may assume full or partial control of the navigation of the vehicle. The navigation system of semi-autonomous vehicles may provide “driver-assist” features in which the navigation system of the vehicle can assume full or partial control of the navigation of the vehicle, but the driver of the vehicle may override or otherwise assume full or partial manual control over the navigation of the vehicle from the navigation system. The techniques disclosed herein provide for very accurate localization of autonomous and semi-autonomous vehicles. The localization techniques can use vehicle radar to detect markers disposed along and/or around a roadway that include a radar reflector. At least a portion of the markers can include a millimeter wave radio-identification tag (RFID-MMID) tag disposed on the marker that can be activated by either a radar signal transmitted by the navigation system of the autonomous or semi-autonomous vehicle and/or by a signal transmitted by an ultra-high frequency (UHF) transmitted of the navigation system of the autonomous or semi-autonomous vehicle. The RFID-MMID tags can be configured to transmit a modulated backscatter signal that includes tag identification information, such as a tag identifier and/or geographical coordinates of the marker on which the RFID-MMID tag is disposed. The navigation system can also include a lidar transceiver that uses a laser instead of radar and is configured to receive reflected laser signals from reflectors disposed on the markers. The navigation system of the autonomous or semi-autonomous vehicle may include a lidar transceiver in addition to or instead of a radar transceiver. The techniques are discussed in detail below with respect to the examples illustrated in FIGS. 1-18B. The use of RFID tags on a least a portion of the markers can provide additional security for the navigation systems of autonomous and/or partially-autonomous vehicles. Conventional navigation systems for such vehicles that rely on optical recognition techniques to recognize objects used for navigation, such as painted lane markers, road signs, lane reflectors, etc., may be more easily subverted by damaging or altering such objects to cause the optical recognition techniques to fail. However, the use of RFID tags may increase the security by making it harder to subvert. The tag information can be protected for from tampering and may be read-only to prevent a malicious party from altering the tag information of the RFID tags of the markers.

The techniques disclosed herein are not limited to navigating an autonomous or semi-autonomous vehicle, and can also be used with robots, drones, and/or other autonomous or semi-autonomous machines that can navigate through an indoor and/or outdoor environment. The technique can use markers similar those disclosed herein disposed along or around navigable regions of indoor and/or outdoor venues through which such autonomous or semi-autonomous machines can navigate. For example, autonomous or semi-autonomous machines may be configured to navigate indoor (or at least partially indoor venues, such as shopping centers, warehouses, housing facilities, storage facilities, and/or factories to deliver goods, perform maintenance, and/or to perform other tasks. In such implementations, the navigation system of the machine can include map information for the indoor and/or outdoor environment that identifies navigable portions of the indoor and/or outdoor environment and that can be used to determine a refined location for the autonomous or semi-autonomous machine by eliminating estimated locations for the machine that fall outside of the navigable areas of the indoor and/or outdoor environment. The map information can comprise two-dimensional (2D) and/or three-dimensional (3D) map information for the indoor and/or outdoor environment. The 2D and/or 3D map information can be used to generate or to estimate a navigation route through the indoor and/or outdoor environment. For implementations where the autonomous or semi-autonomous machine comprises a drone, the 2D and/or 3D map information can be used to generate a flight path or an estimated flight path through the indoor and/or outdoor environment. The terms “road” or “roadway” as used herein can be used to refer broadly to a navigable path through an indoor and/or outdoor environment that may be navigated by any of the various types of autonomous or semi-autonomous machines discussed above. Furthermore, the terms “road map” or “road map information” as used herein can be used to refer broadly to a map or map information that includes information identifying such navigable paths through an indoor and/or outdoor environment.

FIG. 1 is a block diagram of an example operating environment 100 in which the techniques illustrated herein may be implemented. While the example implementation illustrated in FIG. 1 illustrates an example of the techniques disclosed herein implemented on a roadway, the techniques disclosed herein could alternatively be implemented in other types of indoor and/or outdoor environments as discussed above. Furthermore, while the example implementation illustrated in FIG. 1 and those discussed in the various examples in the subsequent figures refer to an autonomous or semi-autonomous vehicle, the techniques disclosed herein are not limited to vehicles and can also be applied to other types of autonomous or semi-autonomous machines, such as those discussed above. The example operating environment 100 illustrates a portion of a roadway 180. The example roadway includes two traffic lines demarcated by a broken center line 190 and two solid lines 185a and 185b demarcating the shoulders of the roadway. The roadway 180 is provided an example for illustrating the techniques disclosed herein. However, these techniques are not limited to this type of roadway, and may be utilized on single-lane roadways, multi-lane roadways having one-way traffic or two-way traffic, highways, expressways, toll-roads, etc. The roadway 189 has a plurality of markers 105 disposed along each side of the roadway 180 and a plurality of markers 115 disposed along the center line 190. Individual markers are identified using a letter. In this example, markers 105a-1051 are disposed along the sides of the roadway 180 and markers 115a-115d are disposed along the center line 190. The spacing and positioning of the markers 105 and the markers 115 are merely an example of one possible layout of the markers 105 and 115. The markers 115 may be reflectors disposed along the road surface, and may be aligned with lane delimiters such as the center line 190. In other implementations, the markers 115 may be disposed along the solid lines 185a and 185b in addition to or instead of along the center line 190. Furthermore, in markers 115 may be utilized in roads ways have more than two traffic lanes, and the markers 115 may be disposed along the roadway in between the lanes of traffic.

Vehicle 110 may be an autonomous or semi-autonomous vehicle. An autonomous vehicle is configured to navigate and travel from one location to another without human input. A semi-autonomous vehicle can be configured to navigate and travel from one location to another without human input or with limited human input. A semi-autonomous vehicle can allow a driver to assume full or partial control over the navigation of the vehicle. The vehicle 110 may be configured to carry passengers and/or goods. The vehicle 110 may be configured to provide a steering console and controls that allows a driver to assume manual control of the vehicle. A driver may be required to utilize vehicles on roadways that do not have the proper infrastructure in place to support autonomous navigate or for emergency situations, such as a failure of the navigation system of the vehicle or other situation requiring that manual control of the vehicle be assumed by a passenger.

The term “marker” as used herein refers to navigation objects that can be placed on or in the road surface, on infrastructure elements (such as bridges, signs, walls, utility poles, etc.) around the road, and/or disposed along, around the sides of, and/or above the road. A marker can include one or more of radar reflector(s) that are configured to reflect radar signals emitted by the navigation system of vehicles travelling along the road, lidar reflector(s) that are configured to reflect lidar signals emitted by the navigation system of vehicles travelling along the road, radio-frequency identification (RFID) tag(s) configured to generate a modulated backscatter signal in response to an interrogation signal emitted by the navigation system of the vehicles travelling along the road, or optical reflector(s) configured to reflect light within the spectrum visible to the typical human eye. The optical reflector(s) can be color coded. The various examples illustrated in the figures and discussed in the disclosure provide examples of marker that can include one or more of these elements.

The markers 105 may be disposed on poles disposed along the sides of the roadway 180. The markers 105 may also be disposed on elements of existing infrastructure, such as road signs, bridges, utility poles, traffic signals, buildings, or other existing infrastructure elements. The markers 105 can include a reflector that is reflective to radar and/or lidar signals transmitted by the navigation system of a vehicle 110. The markers 115 can disposed along the surface of the road, and may be integrated into a reflector that is reflective to radar and/or lidar signal and is applied to or embedded into the road surface. The markers 115 may be implemented in addition to or instead of visible light reflectors that reflect visible light are used to demarcate and to enhance the visibility of travel lanes and other elements of a roadway to drivers in low light situations. The markers 115 can be implemented to include visible light reflectors in addition to one or more reflectors that are reflective to radar and/or lidar signals. Other elements that may be demarcated on roadways include but are not limited to bike lanes, pedestrian lanes, crosswalks, parking spaces, and/or other elements. These elements may be vary depending upon the driving laws in the location in which the roadway is located.

At least a portion of the markers 105 and the markers 115 can include a radio-frequency identification (RFID) tag. The RFID tags may be passive, passive battery-assisted, or active tags. Active tags include a power sources and may be configured to periodically broadcast tag identification information or may be configured to wait for an interrogation signal from a tag reader before transmitting the tag identification information. Passive battery-assisted tags can operate similar to the latter configuration of the active tags. The passive battery-assisted tags includes a battery or other power source onboard and transmits the tag identification information responsive to receiving an interrogation system from a tag reader. Passive tags do not include an onboard power source and instead rely on the radiofrequency energy transmitted by the tag reader to power the passive tag to transmit the tag identification information. The tag identification information can include a tag identifier that provides a unique identifier for the tag and/or geographical coordinates associated with the marker on which the tag is disposed. The tag identification information may be stored in persistent memory of the tag. The persistent memory may, at least in part, be writeable or rewritable such that information can be written to the memory. The tag identifier may be generated and associated with the tag at the time that the tag is manufactured and may be stored in a read-only portion of the memory. The geographic coordinates may be written to the tag at the time that the tag is placed on the marker. A GNSS receiver or other means for determining the geographic coordinates of the marker on which the tag is disposed may be determined, and the geographic coordinates may be written to the tag. In some implementations, the geographic coordinates may be written to a write-once portion of memory to prevent tampering with the geographic coordinate information once the tag has been deployed on a marker. A malicious party may otherwise be able to alter or delete the information stored on the tag, which would cause vehicles relying on the tag identification information to miscalculate their locations or no longer be able to rely on the tags for geographical location information.

Markers similar to those of markers 105 and/or markers 115 discussed above can be used in alternative implementations in which an autonomous or semi-autonomous vehicle or other machine can be configured to navigate an indoor and/or outdoor venue. The markers can be disposed along hallways, passageways, walls, floors, ceilings, and/or other portions of indoor and/or outdoor venue to assist autonomous or semi-autonomous vehicles or other machines to navigate through the indoor and/or outdoor venue. The markers in such implementations can also utilize the spacing patterns and/or color coding patterns discussed below to assist in navigation through the environment.

The RFID tags can be millimeter wave (RFID MMID) tags configured to emit a response to an interrogation signal in the millimeter wave range of the frequency spectrum −30 GHz to 300 GHz and can have a wavelength ranging from 1 millimeter to 10 millimeters. The use of RFID MMID tags is advantageous in autonomous vehicle navigation systems because the vehicle radar system can be adapted to receive modulated millimeter wave signals from RFID MMID tags and use this information in determining a location the vehicle and for navigation of the vehicle along the roadway. The backscatter from the RFID MMID tags can be received by the vehicle radar system and the backscatter signal can be demodulated by the radar to obtain the tag identification information provided by the RFID MMID tags. The navigation system of the vehicle can use one or more signals reflected from the markers 105 and the markers 115 in addition to any tag identification information received from one or more RFID MMID tags disposed on the markers 105 and/or the markers 115 to determine a set of possible locations of the vehicle 110. The navigation system can then compare the one or more estimated locations where the vehicle 110 may be located to a map of the road system to eliminate hypotheses that would place the vehicle 110 off of the road. The RFID tags can be configured to be activated by ultra-high frequency (UHF) interrogation signals that fall with the ultra high frequency band of 300 MHz to 3 GHz and to generate a backscatter signal that falls within the millimeter wave range of the frequency spectrum. The vehicle 110 can include a UHF transmitter for activating the such tags and the radar transceiver of the vehicle can be configured to receive an process the backscatter signal.

A map of marker locations can be created using various techniques. The map of the marker locations can be generated from plans of marker locations to be placed on the roadway, can be generated as the markers are placed on the road, or can be generated by driving vehicles along the road once the markers are in place to generate the map data. The map location can identify the location of the markers 105 and/or the marker 115. The tag identifiers associated with any RFID tags that are disposed on at least a portion of the markers 105 and/or the marker 115 can also be included in the markers. The tag identifiers can be associated with a set of geographic coordinates where the marker on which the tag is disposed is located. The navigation system of a vehicle receiving a backscatter signal from such a tag can determine how far the vehicle is from the marker on which the tag is disposed based on time of flight information. The map of the marker locations can also include markers that do not have an RFID tag disposed on the markers. The markers can include a radar reflector, lidar reflector, or both.

The marker location information and the map information can also be maintained via crowdsourcing techniques in which the navigation systems, such as the one of vehicle 110 or other autonomous or semi-autonomous machines implementing the techniques disclosed herein, can report errors in the marker location information or the map information to a navigation server. The navigation systems can also be configured to report malfunctioning markers to the navigation server. The navigation systems can be configured to report this information to the navigation server via a wireless network connection, such as a WAN or WLAN connection. The navigation server can be maintained by a trusted entity responsible for maintaining marker location information and the map information that can be used by the navigation system. The marker location information and the map information may be downloadable from the navigation server by the navigation system via wireless network connection. The navigation server can be configured to push a notification out to navigation systems subscribed to such updates that indicates when updated marker location information and/or map information is available. In yet other implementations, the navigation system can be configured to contact the navigation server to check for updates periodically or upon demand of a user of the navigation system.

The navigation system can be configured to identify markers that are not located at the location expected in the marker location information. In such situations, the marker location information may have been incorrect or the marker may have been moved or placed in the wrong geographical location. The navigation system can be configured to use various techniques for identifying missing, malfunctioning, or damaged markers. One technique that the navigation system can use is to identify a marker from which no signal was received (either reflected or backscatter) but a signal was expected to be received from the marker based on the location of the vehicle determined by the navigation system. Lack of a signal from the marker could indicate that the marker may have been damaged or obstructed. Lack of a backscatter signal from a marker that includes an RFID-MMID tag could indicate that the tag has been damaged or a power source powering the tag (for those tags having such power sources) has been depleted. For optical tag that utilize optical reflectors, the marker may have been damaged or may be obstructed if the expected reflector color(s) and/or pattern or reflective elements of the marker are not detected. The navigation system can transmit an error report to the navigation server responsive to detecting the absence of an expected marker. The navigation server can be configured to update the marker location information to remove the missing marker, to alert an administrator, and/or to take other corrective action responsive to receiving more than a predetermined number of error reports from navigation systems utilizing the marker map information. Another technique that the navigation system can use to identify a marker that is missing, malfunctioning, or damaged is to compare the compare the expected locations of the markers to an observed location of the marker. If the observed location is more than a threshold distance from an expected location of the marker, the navigation system can report the observed location of the marker to the navigation server. The observed location can be an estimated location of the marker based on a location of the vehicle and time-of-flight information associated with reflected and/or backscatter signals received from the marker. Thus, the observed location may comprise a geographical area in which the marker may be located based on the estimated location the vehicle and the time-of-flight information. The navigation system can be configured to send an error report to the navigation server if the expected location of the vehicle does not fall within the geographical area comprising the observed location of the marker. Another technique that the navigation system can use to identify a marker that is damaged or moved is by demodulating backscatter signals received from markers that include RFID-MMID tags. If the tag information obtained from the demodulated signal does not match that of a marker that is expected to be proximate to at the observed location, the navigation system can generate an error report and send it to the navigation server because the marker may have been moved to a new location or the marker location information may be incorrect. If the navigation system is unable to demodulate the backscatter signal from a marker, the navigation system can be configured to determine an approximate location of the marker based on time-of-flight information and to send an error report to the navigation server indicating that the marker may be damaged.

The navigation server be configured to maintain marker location information and maintain map information for roadways and/or navigable portions of indoor and/or outdoor venues. The navigation server can be configured to receive error reports regarding missing, malfunctioning, or damaged markers. The navigation server can be configured to update the marker location information and/or the map information responsive to receiving a threshold number of error reports from navigation systems utilizing this information and to update the marker location information and/or the map information responsive to such reports. The navigation systems can be configured to utilize encryption and/or other techniques to prevent malicious parties from spoofing or forging error reports to cause the marker location information and/or map information to be altered. Furthermore, the navigation server can be configured to alert an administrator before making an automated changes to the marker location information and/or the map information. The administrator can review the proposed changes to the marker location information and/or the map information, and can approve or deny the changes. The navigation server can also be configured to generate a repair request to dispatch someone to repair or replace missing, malfunctioning, or damaged markers responsive to receiving more than a threshold number of error reports regarding a particular marker.

In some implementations, the markers may be disposed along or proximate to the roadway in a known and predefined coded pattern in which the spacing between the markers is uneven. The navigation system of a vehicle receiving a reflected signal from a group of three or four consecutive poles along the roadway can accurately determine a location of the vehicle along the roadway. The navigation system can use the reflected signals in addition to any RFID backscatter signals from RFID tagged poles to determine a set of hypotheses as to the location of the vehicle by comparing time of flight (TOF) information for the reflected signals with marker map information to determine one or more estimated locations where the vehicle may be located. The navigation system can compare these hypotheses to road map information to eliminate non-relevant hypotheses that would place the vehicle off of a roadway to determine an accurate location for the vehicle (also referred to herein as a “refined location” for the vehicle). In implementations where these techniques are applied to navigation through an indoor and/or outdoor venue, the map information can be for the indoor and/or outdoor venue and can be used to eliminate location hypotheses that fall outside of the navigable areas of the indoor and/or outdoor venue.

In some implementations, at least a portion of the markers can utilize color coding instead or in addition to disposing the markers along the roadway in a predetermined pattern. Sequential markers may include reflectors that are colored in a predetermined pattern that can be used by the navigation system of the vehicle to determine an estimate of the location of the vehicle. In other implementations, at least a subset of the markers can include a multiple reflectors arranged in a predetermined pattern on the marker and the coloration of the reflectors can be selected such that the navigation system can utilize the pattern on the marker to determine an estimated location of the vehicle. The color coding patterns on sequences of markers and/or on particular markers can be included in the marker map information that the navigation unit of the vehicle can access. The navigation unit can compare the patterns of reflector colors observed with the information included in the marker map information to determine one or more estimated locations for the vehicle.

The reflector color and/or spacing patterns can also be used by the navigation system of the vehicle to ensure that the is progressing along an expected route calculated by the navigation system once the location of the vehicle has been refined from the estimated locations. The navigation system can obtain marker pattern information from the marker map information stored in the navigation system to determine an expected marker pattern for markers that will be encountered along the route. The navigation system can compare this expected marker pattern information with markers observed as the vehicle continues to travel along the route to determine whether the vehicle is an expected location along the route. The navigation system can also use map information of markers having RFID-MMID tags to identify RFID tagged markers that the vehicle is expected to observe along the route and to compare this expected RFID tagged markers with markers observed as the vehicle continues to travel along the route to determine whether the vehicle is an expected location along the route. The navigation system of the vehicle can also be configured to use a combination of the marker patterns and RFID tagged markers to make a determination whether the vehicle is progressing along an expected route.

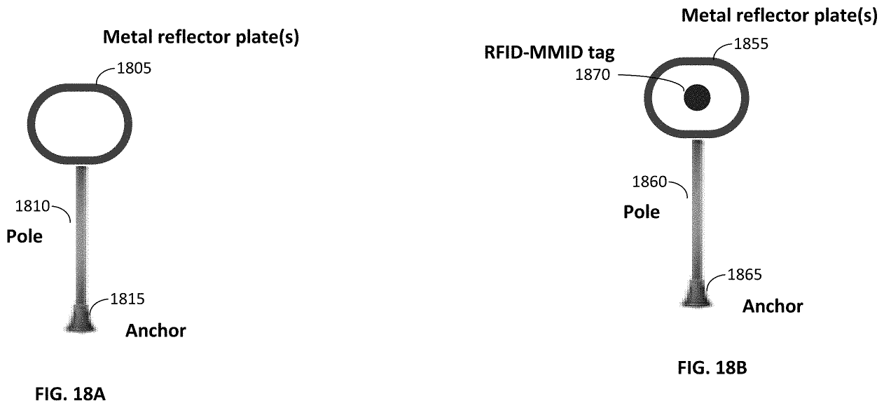

FIGS. 18A and 18B illustrate example marker disposed on poles that can be used to implement the markers 105 illustrated in FIG. 1 and can be used to implement the markers of the various processes disclosed herein. FIG. 18A illustrates an example marker that comprises one or more metal reflective plates 1805 disposed on a pole 1810 that can be anchored with anchor 1815 in the ground along the roadway. The metal reflective plate(s) 1805 are configured to reflect radar signals transmitted by the radar transceiver of the navigation system of the vehicle 110. Similar markers may be utilized for navigating indoor and/or outdoor venues. However, the pole may not be necessary for at least a portion of the markers and the markers may be disposed on walls, floors, ceilings, and/or other elements of the indoor and/or outdoor venues.

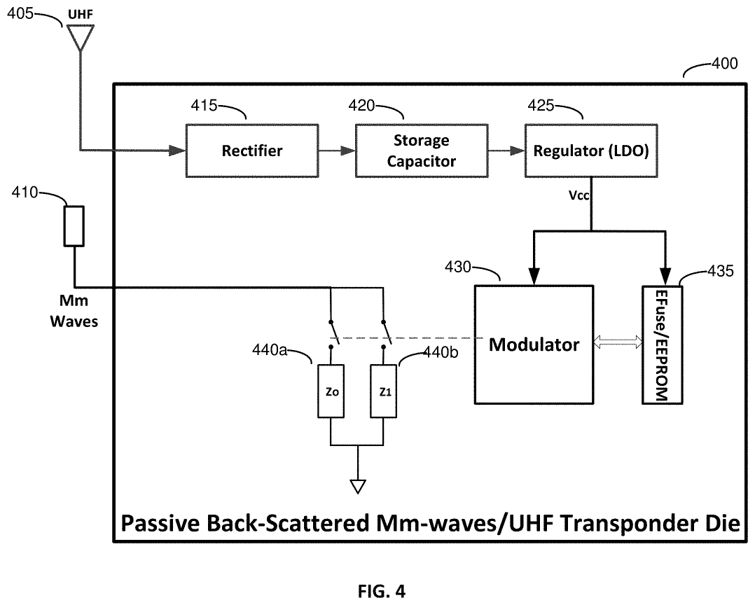

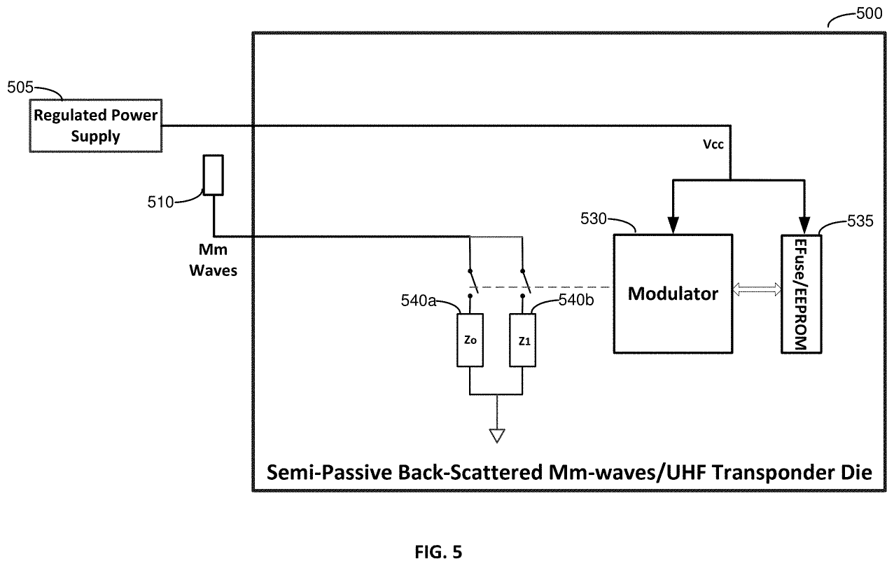

FIG. 18B illustrates another example implementation of markers that are similar to those illustrated in FIG. 18A. The marker includes reflector plate(s) 1855 which are similar to the reflector plate(s) illustrated in the preceding figure. The marker also includes pole 1860 for supporting the reflector plate(s) 1855 and an anchor for anchoring the marker in the ground along the roadway. The example marker illustrated in FIG. 18B includes an RFID-MMID tag that is configured to respond to an interrogation signal from the navigation system of the vehicle 110 and to return a backscatter signal that the navigation system can process. The RFID-MMID tag can be configured to return a modulated backscatter signal that includes tag information, such as a tag identifier and/or geographical coordinates to the marker on which the tag is disposed. Example implementations such tags are illustrated in FIGS. 4 and 5, which are discussed in detail below.

Alternative implementations of the markers illustrated in FIGS. 18A and 18B can comprise means for anchoring the metal reflective plate portion (with our without a RFID-MMID tag) onto existing infrastructure, such as road signs, walls, bridges, utility poles, etc. rather than anchoring the markers directly into the ground along the road. Furthermore, in some implementations, the markers illustrated in FIGS. 18A and 18B may include reflective plates that are configured to reflect laser light emitted by lidar system in addition to or instead of the radar reflective places 1805 and 1855 illustrated in FIGS. 18A and 18B.

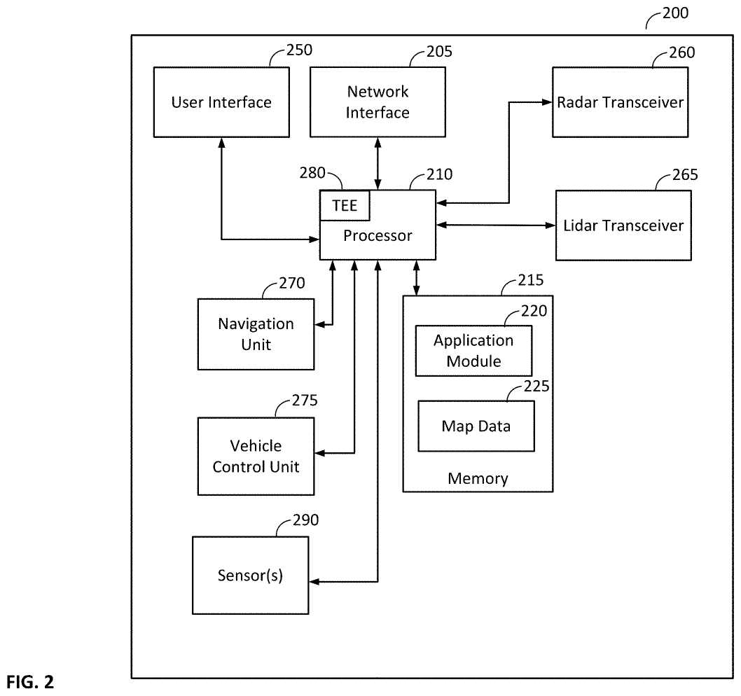

FIG. 2 is a functional block diagram of an example computing device 200 that can be used to implement the navigational and driving control systems of the vehicle 110 illustrated in FIG. 1. Such a computing device 200 can alternatively be used as a navigational and control system for other types of autonomous or semi-autonomous devices as discussed above. The computing device 200 can be an in-vehicle computer system that can provide network connectivity for downloading network content and application, navigational data, and/or other content that may be viewed or executed using the computing device 200. For the sake of simplicity, the various features/components/functions illustrated in the schematic boxes of FIG. 2 are connected together using a common bus to represent that these various features/components/functions are operatively coupled together. Other connections, mechanisms, features, functions, or the like, may be provided and adapted as necessary to operatively couple and configure a navigational and driving control system. Furthermore, one or more of the features or functions illustrated in the example of FIG. 2 may be further subdivided, or two or more of the features or functions illustrated in FIG. 2 may be combined. Additionally, one or more of the features or functions illustrated in FIG. 2 may be excluded.

As shown, the computing device 200 can include a network interface 205 that can be configured to provide wired and/or wireless network connectivity to the computing device 200. The network interface can include one or more local area network transceivers that can be connected to one or more antennas (not shown). The one or more local area network transceivers comprise suitable devices, circuits, hardware, and/or software for communicating with and/or detecting signals to/from one or more of the WLAN access points, and/or directly with other wireless devices within a network. The network interface 205 can also include, in some implementations, one or more wide area network transceiver(s) that can be connected to the one or more antennas (not shown). The wide area network transceiver can comprise suitable devices, circuits, hardware, and/or software for communicating with and/or detecting signals from one or more of, for example, the WWAN access points and/or directly with other wireless devices within a network. The network interface 205 is optional any may not be included in some implementations of the computing device 200.

The network interface 205 may also include, in some implementations, an SPS receiver (also referred to as a global navigation satellite system (GNSS) receiver) 908 may also be included with the computing device 200. The SPS receiver may be connected to the one or more antennas (not shown) for receiving satellite signals. The SPS receiver may comprise any suitable hardware and/or software for receiving and processing SPS signals. The SPS receiver may request information as appropriate from the other systems, and may perform the computations necessary to determine the position of the computing device 200 using, in part, measurements obtained by any suitable SPS procedure. The positioning information received from the SPS receiver can be provided to the navigation unit 270 for determining a location of the vehicle 110 and for navigating the vehicle 110 along a roadway.

The processor(s) (also referred to as a controller) 210 may be connected to the memory 215, the navigation unit 270, the vehicle control unit 275, the user interface 250, the network interface 205, the radar transceiver 260, and the lidar transceiver 265. The processor may include one or more microprocessors, microcontrollers, and/or digital signal processors that provide processing functions, as well as other calculation and control functionality. The processor 210 may be coupled to storage media (e.g., memory) 215 for storing data and software instructions for executing programmed functionality within the computing device. The memory 215 may be on-board the processor 210 (e.g., within the same IC package), and/or the memory may be external memory to the processor and functionally coupled over a data bus.

A number of software modules and data tables may reside in memory 215 and may be utilized by the processor 210 in order to manage, create, and/or remove content from the computing device 200 and/or perform device control functionality. As illustrated in FIG. 2, in some embodiments, the memory 215 may include an application module 220 which can implement one or more applications. It is to be noted that the functionality of the modules and/or data structures may be combined, separated, and/or be structured in different ways depending upon the implementation of the computing device 200. The application module 220 can comprise one or more trusted applications that can be executed by the trusted execution environment 280 of the computing device 200.

The application module 220 may be a process or thread running on the processor 210 of the computing device 200, which may request data from one or more other modules (not shown) of the computing device 200. Applications typically run within an upper layer of the software architectures and may be implemented in a rich execution environment of the computing device 200, and may include navigation applications, games, shopping applications, content streaming applications, web browsers, location aware service applications, etc.

The processor 210 may include a trusted execution environment 280. The trusted execution environment 280 can be used to implement a secure processing environment for executing secure software applications. The trusted execution environment 280 can be implemented as a secure area of the processor 210 that can be used to process and store sensitive data in an environment that is segregated from the rich execution environment in which the operating system and/or applications (such as those of the application module 220) may be executed. The trusted execution environment 280 can be configured to execute trusted applications that provide end-to-end security for sensitive data by enforcing confidentiality, integrity, and protection of the sensitive data stored therein. The trusted execution environment 280 can be used to store encryption keys, vehicle configuration and control information, navigation information for use in autonomous driving, and/or other sensitive data.

The computing device 200 may further include a user interface 250 providing suitable interface systems for outputting audio and/visual content, and for facilitating user interaction with the computing device 200. For example, the user interface 250 may comprise one or more of a microphone and/or a speaker for outputting audio content and for receiving audio input, a keypad and/or a touchscreen for receiving user inputs, and a display (which may be separate from the touchscreen or be the touchscreen) for displaying visual content.

The radar transceiver 260 can be configured to transmit radar signals from the vehicle 110 and to receive reflected radar signals reflected by reflectors, such as the reflectors 105 and the reflectors 115. The radar receiver 260 can also be configured to receive backscattered signals from RFID MMID tags embedded in one or more of the reflectors 105 and/or the reflectors 115, and to demodulate the transmitter identification information included in the backscattered signals received from the RFID MMID tags. The radar receiver 260 can be configured to provide ranging information (e.g. distance of the vehicle 110 from one or more markers) to the navigation unit 270. The radar receiver 260 can also be configured to provide transmitter identification information from any RFID MMID tags to the navigation unit 270. The radar transceiver 260 can also be used to identify objects proximate to the vehicle 110 that may obstruct the vehicle and/or pose a collision hazard, such as but not limited to pedestrians, objects in the roadway, and/or other vehicles on the roadway. The radar transceiver 260 can provide object detection information to the navigation unit 270.

The lidar transceiver 265 is optional. In some implementations of the computing device 200, the lidar transceiver 265 is included and in other implementations, the lidar transceiver 265 is included. The lidar transceiver 265 can be configured to emit a laser signal that can be reflected by reflectors, such as the reflectors 105 and the reflectors 115. The lidar transceiver 265 can also be used to identify objects proximate to the vehicle 110 that may obstruct the vehicle and/or pose a collision hazard, such as but not limited to pedestrians, objects in the roadway, and/or other vehicles on the roadway. The lidar transceiver 265 can provide object detection information to the navigation unit 270.

The vehicle control unit 275 can be configured to control various components of the vehicle 110 to cause the vehicle to move along a route determined by the navigation unit 270. The vehicle control unit 275 can be configured to be communicatively coupled with the navigation unit 270 and can be configured to receive information from the navigation unit 270 and to provide information to the navigation unit 270. The vehicle control unit 275 can be configured to output signals to one or more components of the vehicle to control acceleration, braking, steering, and/or other actions by the vehicle. The vehicle control unit 275 can also be configured to receive information from one or more components of the vehicle and/or sensors, including the navigation unit 270, that can be used to determine a current state of the vehicle. The current state of the vehicle can include a location of the vehicle, a speed of the vehicle, acceleration of the vehicle, direction of travel of the vehicle, which gear the vehicle is currently configured to operate in, and/or other information regarding the state of the vehicle. In implementations where the navigation system is included in other types of autonomous or semi-autonomous device, a control unit configured to control the autonomous or semi-autonomous device can be substituted for the vehicle control unit 275.

The navigation unit 270 can be configured to receive ranging information and tag identification information (where available) from the radar transceiver 260. The navigation unit 270 can also be configured to receive ranging information from the lidar transceiver 265, where the computing device 200 includes the lidar transceiver 265. In some implementations, the computing device 200 may include both a radar transceiver 260 and a lidar transceiver 265, because some roadways may be equipped with markers that a radar reflective and can be used with the radar transceiver 260 and other roadways may be equipped with markers that are laser reflective and can be used with the lidar receiver 260. Different jurisdictions may adopt different technologies, and some implementations can be configured to support both radar and lidar implementations to allow the vehicle 110 to navigate and drive through areas supporting either or both of these technologies. Furthermore, markers may be color coded, such as with one or more reflectors having different colors placed on the poles. The color coding patterns on sequences of markers and/or on particular markers can be included in the marker map information that the navigation unit of the vehicle can access. The navigation unit can compare the patterns of reflector colors observed with the information included in the marker map information to determine one or more estimated locations for the vehicle. In some implementations, the navigation unit can be configured to utilize a combination of two or more of reflected radar and/or lidar signals, marker spacing patterns, backscatter signals from RFID-MMID tags, and marker color coding to come to a localization solution for the vehicle 110. The usage of more than one localization technique can be particularly useful in bad weather conditions which may interfere with one or more of the techniques discussed herein by attenuating reflected and backscatter signals and/or making detection of visual reflector colorations difficult.

The navigation unit 270 can also be configured to identify missing, malfunctioning, or damaged markers using the techniques discussed above. The navigation unit can be configured to perform a localization procedure according to the techniques disclosed herein to determine a location of the navigation unit 270 (and thus, the vehicle or machine in which the navigation unit is disposed). The navigation unit 270 can use the map information and marker location information to continue to navigate along a roadway or other navigable environment once a location is determined. The navigation unit 270 can use the map information and marker location information to determine which markers the vehicle should be approaching and can use this information to identify missing, malfunctioning, or damaged markers using the techniques discussed above. The navigation unit 270 can send an error report to the navigation server responsive to identifying a missing, malfunctioning, or damaged marker.

The navigation unit 270 and the vehicle control unit 275 can be implemented in hardware, software, or a combination thereof. The navigation unit 270 and the vehicle control unit 275 may be implemented at least in part by software executed by the trusted execution environment 280 to prevent the navigation unit 270 and the vehicle control unit 275 from being tampered with by a malicious third party that wishes to interfere with navigation of the vehicle 110 and/or to assume control of the vehicle 110.

The sensor(s) 290 can comprise one or more sensors that can be used to assist to collect data that can be used to assist in navigation of the vehicle. The sensor(s) 290 can output sensor data that the navigation unit 270 can use in addition to the information received from the network interface 205, the radar receiver 260, and the lidar receiver 265. The sensor(s) 290 can include one or more optical sensors, such as still or video cameras, that can be used to capture information about the area surrounding the vehicles, such as lane markings, signage, reflector colorations and/or patterns, the presence of objects and/or other vehicles proximate to the vehicle, and other such information.

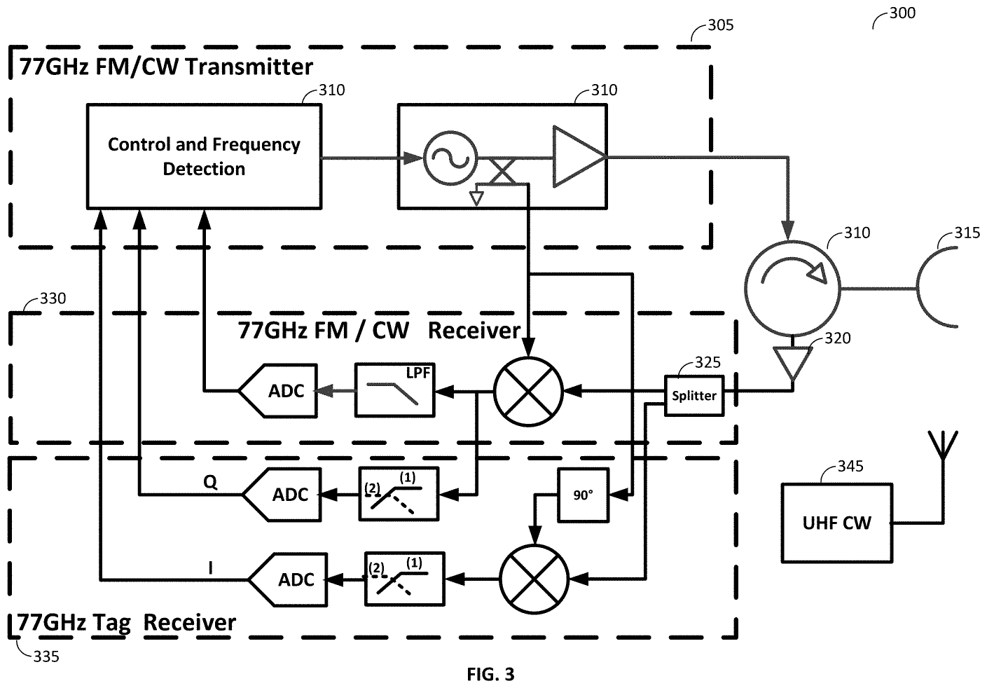

FIG. 3 is a is a functional block diagram of an radar transceiver 300 that can be used to implement the radar transceiver of the vehicle 110 illustrated in FIG. 1 and the radar transceiver 260 illustrated in FIG. 2. Such a radar transceiver 300 can alternatively be used as a navigational and control system for other types of autonomous or semi-autonomous devices as discussed above. The radar transceiver is modified to receive radar signals that have been reflected from the markers 105 and/or the markers 115 and to receive backscattered signals from RFID MMID tags that may be embedded in some or all of the markers 105 and/or markers 115.

The radar transceiver 300 includes a transmit path 305 that includes a control and frequency detection unit 310 and a front-end unit 310. The control and frequency detection unit 310 can be configured to generate and output a signal to the front-end unit 310. The front-end unit 310 can include an oscillator and an amplifier and output a signal to the circulator 310. The circulator 310 is communicatively coupled to the antenna 315 and the input to the receiver (via the amplifier 320). The antenna 315 transmits a radar signal based on the signal output by the control and frequency detection unit 310. The radar signal transmitted by the antenna 315 can reflect off the reflectors of the markers 105 and/or markers 115 proximate to the vehicle 110. The radar signal transmitted by the antenna 315 falls within the millimeter band ranging from 30 to 300 gigahertz. In some implementations, the radar signal transmitted by the radar transceiver 300 is in the range of 77 to 79 GHz.

The radar transceiver 300 can also include or be communicatively coupled with a UHF continuous wave (CW) transmitter 345. The UHF CW transmitter 345 can be configured to transmit a continuous wave ultra-high frequency signal that can be received by UHF RFID tags. The UHF CW transmitter 345 can be used to charge passive RFID-MMID tags over the air to allow the tag to generate a modulated backscattered radar signal within the millimeter range. For example, the backscattered signal can fall within the 77 GHz to 79 GHz range in implementations where such a range is used by the transmit path 305 of the radar transceiver 300. In some implementations, some or all of the RFID tags disposed on some or all of the markers 105 and/or markers 115 may be UHF RFID tags that respond to an UHF frequency signal instead of a millimeter frequency signal such as that generated by the radar transceiver 300. The UHF RFID tags can be configured to receive a UHF signal but to respond with a millimeter wave signal. An example implementation of such a tag can be found in FIGS. 4 and 5, which is discussed in greater detail below. Alternatively, the RFID tags deployed on at least some of the markers 105 and/or the markers 115 can be configured to receive a millimeter wave signal, such as that transmitted by the radar transceiver 300 and to respond with a millimeter wave signal response.

The radar transceiver 300 includes two receive paths. The splitter 325 splits the signal output by the amplifier 320 and feeds it to each of the receive paths. The first receive path 330 is configured to receive and process reflected signals and the second receive path 335 is configured to receive and demodulate modulated backscattered radar signals received from RFID MMID tags disposed on markers 105 and/or markers 115. The second receive path 335 includes receive chains for processing the I (in-phase) and Q (quadrature) to demodulate the backscatter signal received from the RFID MMID tags. The outputs from the first receive path 330 and the second receive path 335 are provided to the control and frequency detection unit 310.

The control and frequency detection unit 310 can be configured output ranging information and tag identification information (where available) that can be used by the navigation unit 270 of the vehicle to navigate the vehicle along a roadway. The ranging information indicates how far away a marker 105 or marker 115 is from the vehicle at the time that radar signal was transmitted by the radar transceiver 300 and reflected back by the marker 105 or marker 115. The ranging information be determined by calculating a time of flight (TOF) for a radar signal reflected based on the time that radar signal was transmitted by the radar transceiver 300 and the time at which the reflected signal was received at the radar transceiver 300. The tag identification information included in the modulated backscatter signal from RFID MMID tags can also be provided to the navigation unit 270. The tag identification information can include a unique identifier associated with the RFID MMID tag that the navigation unit 270 can look up in a marker map to determine an exact location for the marker. The using this information and the reflected radar signals from one or more markers 105 and/or markers 115, the navigation unit 270 can determine one or hypotheses as to location of the vehicle. The navigation unit 270 can compare these hypotheses to road map data to eliminate hypotheses that would place the vehicle off of a roadway. By eliminating these hypotheses, the actual location of the vehicle can be determined. The navigation unit 270 can supplement the information received from the radar transceiver 300 with information received from a GNSS transceiver and/or a lidar transceiver where such transceivers are included in the computing system 200 of the vehicle 110. As discussed above, the markers may be disposed along the road in a particular pattern and/or may have color reflectors color coded in a predetermined pattern that that can also be used to determine hypothesis for the location of the vehicle. The navigation unit can consider the pattern information in addition to the RFID-MMID tag information when determining the estimated locations of the vehicle 110.

The techniques disclosed herein can utilize various types of RFID-MMID tags. Passive RFID-MMID tags may provide a coverage area of just less than ten meters (meaning that if the tag is more than ten meters from the vehicle emitting the signal that triggers then the radar signal or UHF signal reaching the tag is likely to be insufficient to power the tag to generate the backscatter signal). Semi-passive RFID-MMID tags may provide a slightly greater coverage area. The semi-passive tags include a regulated power supply that is configured to power the tag so that the received signal does not have to be received with sufficient power to power the tag to generate the backscatter signal. Active RFID-MMID tags can have an even greater range. For example, such tags may have a range of approximately 40 meters. Active RFID tags have a power supply and are configured to broadcast a signal periodically without relying on detecting and responding a signal transmitted by the radar transceiver or UHF transmitted of the navigation system of the vehicle 110.

FIG. 4 is a is a functional block diagram of a RFID tag 400 that can be used to implement tags that can be used to implement the techniques disclosed herein, such as the markers 105 and/or markers 115 illustrated in FIG. 1. Such an RFID tag may also be used in implementations in which markers are used to navigate an indoor and/or outdoor venue, such as those discussed above. RFID tag 400 is a passive RFID tag that is powered by RF signals transmitted by a UHF transmitter. The example RFID tag 400 is configured to receive a UHF signal from a UHF transmitter, such as the UHF CW transmitter 345 illustrated in FIG. 3 that may optionally be included in or associated with the radar transceiver 300 of the vehicle 110. The example RFID tag 400 is configured to reflect back an altered signal (also referred to as “backscatter”) using the mm-wave antenna 410. The backscatter is emitted as millimeter waves that can be received by the radar transceiver 300 and processed and demodulated as discussed above with respect to FIG. 3.

The UHF antenna 405 converts UHF signals received by the antenna to an electrical current that rectifier 415 can convert to direct current (DC). The DC output of the rectifier 415 is received by the storage capacitor 420, which can smooth the output of the rectifier 415. The output of the capacitor 420 can be received by the low-dropout (LDO) regulator 425, which is configured to regulate the voltage even when the supply voltage received from the capacitor 420 is close to the output voltage. The output of the LDO regular 425 is provides power to the memory 435, the modulator 430, and/or other components of the RFID tag 400. The memory 435 can comprise electrically erasable programmable read-only memory (EEPROM) or other type of programmable read-only memory. The memory 435 can store tag identification information and/or other information, such a geographical coordinates of the marker on which the tag is disposed and/or neighboring tag information, that can be used by the modulator 430 when modulating the backscatter signal to be returned to the transmitter. The modulator 430 can switch control the switches 440a and 440b to switch between a first path and a second path in order to adjust the impedance to generate the backscattering modulation of the millimeter wave signal output by the antenna 410.

The RFID tag 400 can be configured to operate using millimeter waves rather that UHF, because the millimeter waves can produce better results in bad weather conditions, such as snow, rain, and fog. Furthermore, the use of RFID-MMID tags can provide better performance over localization solutions that rely on GNSS signals and/or computer vision solutions that rely on capturing images and/or video of the environment surrounding the vehicle in order to perform localization and navigation functions. Visual solutions are affected by weather conditions and lighting conditions which do not impact or have much less of an impact on the transmission of millimeter waves.

FIG. 5 is a is a functional block diagram of a RFID tag 500 that can be used to implement tags that can be used to implement the techniques disclosed herein, such as the markers 105 and/or markers 115 illustrated in FIG. 1. Such an RFID tag may also be used in implementations in which markers are used to navigate an indoor and/or outdoor venue, such as those discussed above. RFID tag 500 is a semi-passive RFID tag that is powered by a regulated power supply 505. The regulated power supply 505 can comprise a battery, a photovoltaic panel, or other source of power for the RFID tag 500. The regulated power supply 505 can power the modulator 530, the memory 535, and/or other components of the RFID tag 500. The inclusion of the regulated power supply 505 can provide the RFID 500 with increased read distance compared to the passive RFID 400 illustrated in FIG. 4 because the received UHF signal transmitted by the navigation system of the vehicle 110 does not need to be powerful enough to power the modulator 530, memory 535, and/or other components of the RFID 500. Instead, the RFID tag 500 can be configured to detect the UHF signal and to generate the backscatter signal even where the received signal would have been insufficient to power the RFID tag 400 illustrated in FIG. 4. The regulated power supply 505 can thus provide the RFID tag 500 with a longer read range, since the signal received by the RFID tag 500 does not need to meet a minimum power threshold required to power the components of the RFID tag 500 to generate the backscatter signal.

The memory 535 can be similar to the memory 435 of the RFID tag 400 illustrated in FIG. 4, and the modulator 530 can be similar to the modulator 430 of RFID tag 400 illustrated in FIG. 4. The modulator 530 operates similarly to that illustrated in FIG. 4. The modulator 530 modulates the backscatter signal and a millimeter wave signal that can be received and demodulated by the radar transceiver 300 illustrated in FIG. 3. The modulator 530 can switch control the switches 540a and 540b to switch between a first path and a second path in order to adjust the impedance to generate the backscattering modulation of the millimeter wave signal output by the antenna 410.

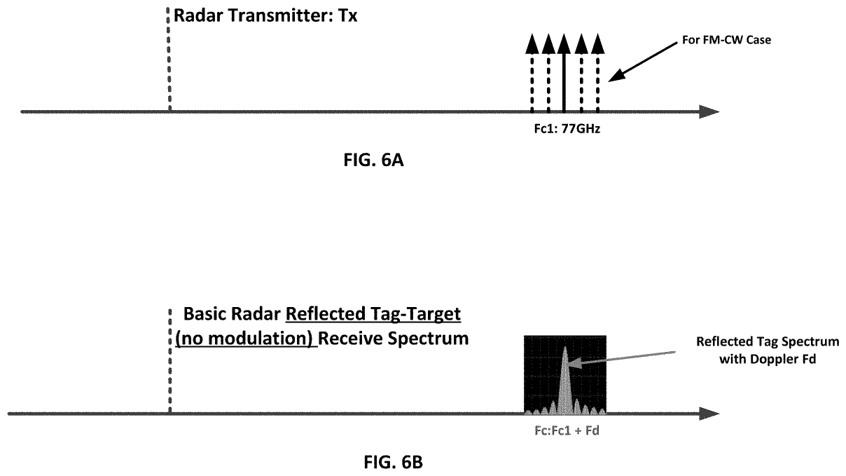

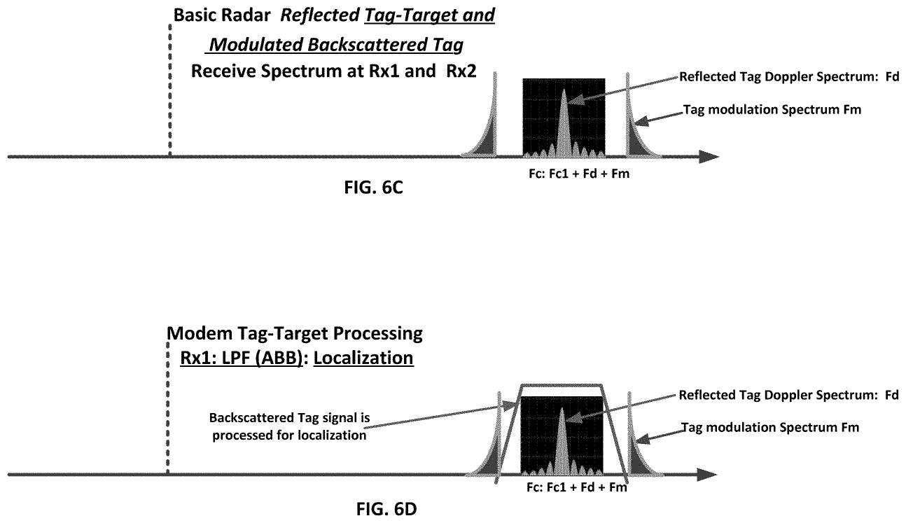

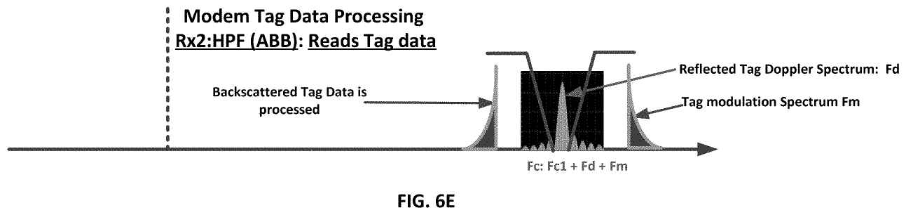

FIGS. 6A, 6B, 6C, 6D, and 6E illustrate an example process for tag data processing and localization according to the techniques disclosed herein. FIG. 6A illustrates a radar transmission made by the radar transmission can, for example, be a frequency-modulated continuous-wave (FM-CW) transmission or an Ulta-wideband (UWB) transmission. FM-CW is a short range measuring radar capable of determining distance from the transmitted to objects that reflect the radar signals. In FW-CW, a known stable frequency continuous wave is varied up and down in frequency over a fixed period of by a modulating signal. FM-CW can provide both distance and speed measurements. Distance can be determined based by determining the frequency distance between the receive signal and the transmit signal. The frequency difference increases as the distance between the transmitter and the object reflecting the radar signal increases. UBW utilizes pulse transmissions instead of a continuous wave transmission, and can also be used to determine distance and velocity. The example illustrated in FIG. 6A is a FM-CW radar transmission centered around 77 GHz. FIG. 6B illustrates an example of a receive spectrum for an implementation where the marker reflects a signal which can then be received by the radar transceiver 260. In contrast, FIG. 6C illustrates an example where the marker includes an RFID-MMID tag configured to generate a modulated backscatter signal and the reflector also reflects the radar signal. In this example, the RFID-MMID tag is configured to generate a modulated backscatter signal is at a frequency above the radar upper Doppler frequency. As can be seen in FIG. 6C, the modulated spectrum of the backscatter signal is separate from the reflected Doppler spectrum of the reflected radar signal. The reflected radar signal can then be separated by the modulated backscatter signal from the RFID-MMID tag by the radar transceiver (as discussed above with respect to FIG. 3). The radar receiver 300 includes a first receive path 330 for processing the reflected radar signals reflected by a marker and a second receive path 335 for processing the modulated backscatter signals from the RFID-MMID tag disposed on the marker. As illustrated in FIG. 6E, the first receive path 330 can include a low pass filter that attenuates the modulated signal from the tag while allowing the reflected radar signal to pass through, and as illustrated in FIG. 6D, the second receive path 335 can include a high pass filter that attenuates the reflected radar signal while allowing the modulated signal from the to pass through. The time of flight information for the reflected radar signals processed by the first receive path 330 can be determined in order to determine tag localization based on the TOF information. Tag information can be obtained from the modulated backscatter signals, which can include a tag identifier for the tag, for neighboring tags, and geographic coordinates of the tag and or the neighboring tags. The time of flight information and/or tag information obtained from the signals can be provided to the navigation unit 270, which can use this information to determine estimated locations for the vehicle 110. The estimated locations for the vehicle 110 can be refined using backscatter signals from two or three RFID-MMID poles since the tag information include geographical coordinates. The navigation unit 270 can also use road map information to eliminate hypotheses which would place the vehicle 110 off of a roadway in order to determine the refined location of the vehicle 110.

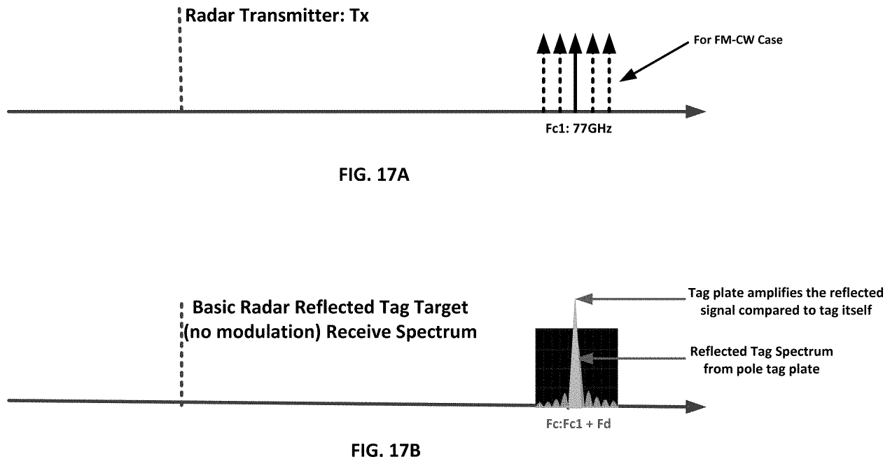

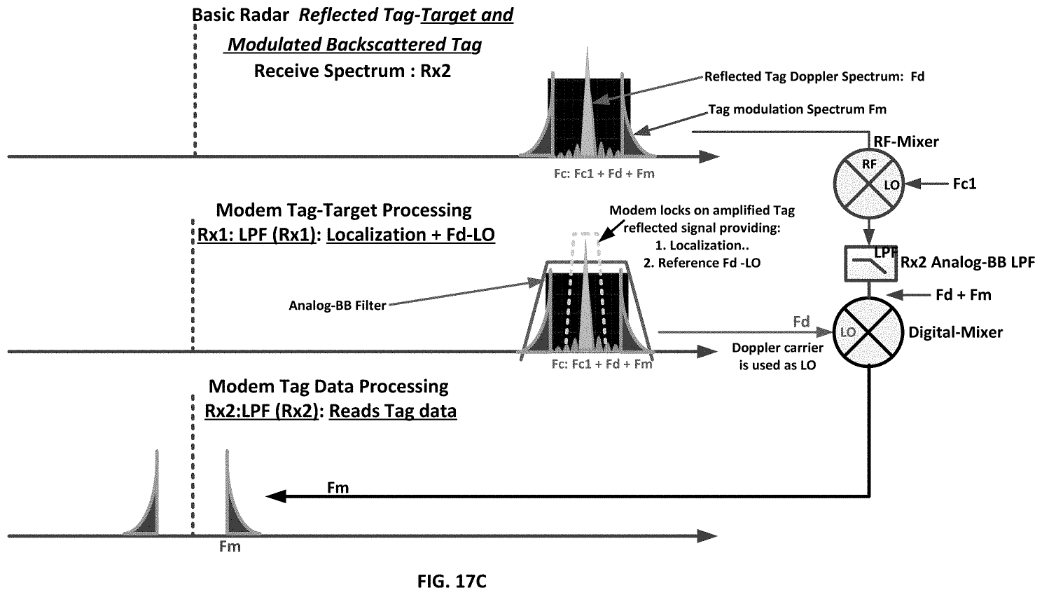

FIGS. 17A, 17B, and 17C illustrate another example process for tag data processing and localization according to the techniques disclosed herein. In the example illustrated in FIGS. 17A, 17B, and 17C, the RFID-MMID tag is disposed on a pole having a reflector plate or plates, which can be similar to that of the example marker illustrated in FIG. 18B. The reflector plate(s) can amplify the reflected signal compared to the implementations of a marker that do not include such a reflector plate, such as the example illustrated in FIG. 6B which illustrate that the received reflected signal may be weaker without such a reflector plate. FIG. 17A is similar to that of FIG. 6A, in which the radar transceiver of the navigation system of the vehicle 110 transmits a signal. FIG. 17B is similar to that of FIG. 6, which illustrates that the reflected signal can be received by the radar transceiver of the navigation system of the vehicle, except as discussed above, the strength of the reflected signal may be greater due to the use of the reflective plate(s). The reflective plates have a large radar signature for facilitating the reflecting of the radar signals back to the radar transceiver of the navigation system of the vehicle 110. The example illustrated in FIGS. 6A, 6B, 6C, 6D, and 6E may also use a reflector similar to that illustrated in FIG. 18A in which some of the markers do not include RFID-MMID tags.

FIG. 17C is similar to FIGS. 6C-6E. In the example implementation of FIGS. 17A, 17B, and 17C, the reflective radar signal from the reflective plates of the marker that includes the RFID-MMID tags can reach the radar transceiver of the navigation system at a relatively high level and is detected by the first receive path 330 of the radar receiver. FIG. 17B illustrates a spectrum example in which a reflected radar signal is received from a marker that does not included a modulated signal from an RFID-MMID tag. Such a signal may be received from a marker similar to that of the example marker illustrated in FIG. 18A. The first receive path 330 of the radar receiver can estimate the Doppler frequency (Fd) and an accurate distance between the vehicle 110 and the marker based on time of flight (TOF) calculations based on the transmit time of the original signal and the receive time of the reflected signal. FIG. 17C illustrates an example received spectrum (top spectrum example) in which the RFID-MMID tag was included on the reflector, such as in the example marker of FIG. 18B, in which reflected radar signals at the Doppler frequency (F_{d}) and a modulated backscatter signal at the frequency (Fₘ) are received. The combination of Doppler data and modulated tag data can be processed by the second receive path 335 of the radar receiver. The combined data is passed through an RF mixer with transmit frequency utilized by the car radar (F_{cl}) (see FIG. 17A) as the second input to the mixer. The output from the mixer is pass through a low pass filter, and the resulting output is a combination of the Doppler frequency (F_{d}) of the reflected signals and the frequency of the modulated backscatter signal (Fm). This resulting output is then input as a first input to a digital mixer with the second input to the digital mixer being the Doppler carrier frequency (F_{d}). The resulting output is the modulated backscatter frequency (Fm) of the RFID-MMID tag. The modulated backscatter frequency data can be demodulated by the second receive path 335 of the radar transceiver to demodulate the tag information included therein. As discussed above, the tag information can include a tag identifier and/or geographical coordinates of the marker on which the tag is disposed. The tag information can also include information for identifying neighboring tags and the geographical coordinates of the markers on which these tags are disposed.

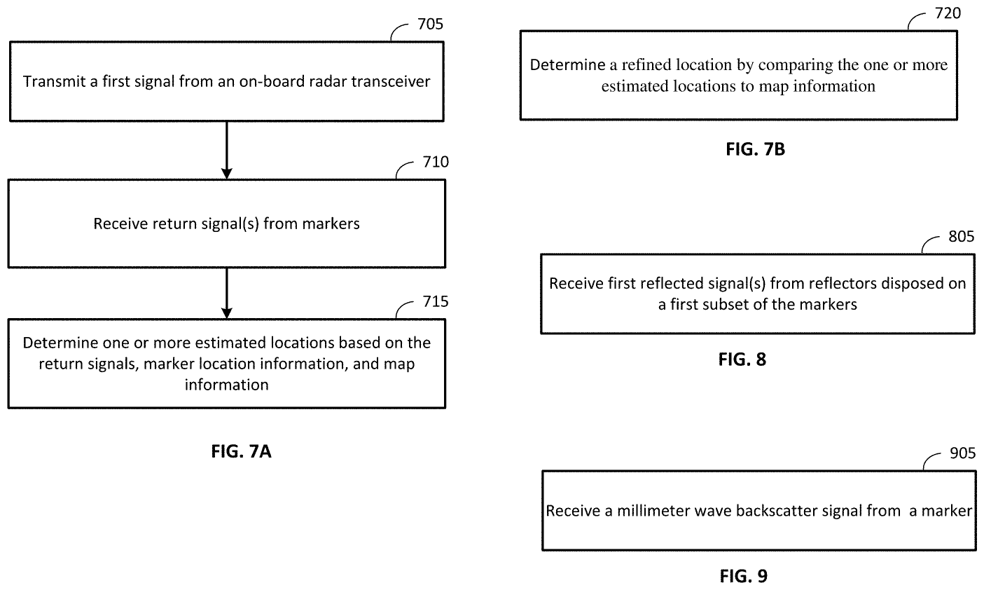

FIG. 7A is a flow diagram of a process for navigation. The vehicle may be an autonomous or semi-autonomous vehicle (which is used to illustrate this particular example implementation) or other types of autonomous or semi-autonomous devices. The process illustrated in FIG. 7A can be implemented by the navigational and driving control systems of the vehicle 110 illustrated in FIG. 1. The computing device 200 of FIG. 2 can provide the means for implementing the navigational and driving control systems of the vehicle 110 and for implementing the process illustrated in FIG. 7A.

A first signal can be transmitted by an onboard radar transceiver (stage 705). The radar transceiver 260 of the vehicle 110 can be implemented by the radar transceiver 300 illustrated in FIG. 3. The radar transceiver 260 can be configured to transmit the first signal in the 77 to 79 GHz frequency range. The radar transceiver 260 may be configured to operate in other frequency ranges depending upon the locality of the vehicle 110. Different localities may allocate difference frequency bands for use by automotive radar systems. The radar transceiver 260 can be configured to utilize a pulsed radar technique in which the radar transceiver 260 is configured to transmit a pulse of radio waves at a known frequency and measuring the elapsed time between transmitting the pulse and receiving radio waves that have been reflected from an object. In some implementations, the computing device 200 of the vehicle 110 can include a lidar transceiver 265 instead of or in addition to the radar transceiver 260. In such implementations, the lidar transceiver 265 can be configured to emit a laser light pulse and to measure the elapsed time between transmitting the pulse of laser light and receiving laser light that has been reflected from an object. More than one vehicle may be and is likely to be on the road at the same time. Accordingly, the radar transceiver 260 and/or the lidar transceiver 265 can be configured to utilize a unique (or relatively unique) signal pulse pattern that the radar transceiver 260 and/or the lidar transceiver 265 can identify in the reflected signals to reduce interference from other vehicles using similar techniques for navigating the road proximate to the location of the vehicle 110.

One or more return signals can be received from markers (stage 710). As illustrated in FIG. 1, markers 105 and/or the markers 115 can be disposed either along the side(s) of the road and/or disposed along the road surface. The markers may also be disposed proximate to the road. For example, the markers may be disposed on infrastructure elements (such as bridges, signs, walls, utility poles, etc.). The signal transmitted in the preceding stage can be reflected from one or more of the markers 105 and/or the markers 115. As discussed above, the markers 105 and/or the markers 115 can comprise reflective elements that reflect a radiofrequency signal transmitted by the radar transceiver 260 or a lidar pulse transmitted by the lidar transceiver 265 back to the vehicle 110. As also discussed above, one or more of the markers 105 and/or the markers 115 can include an RFID-MMID tag that is configured to respond to the radar signal or to a UHF signal transmitted by a UHF transmitter 345 of the vehicle 110 with a backscatter signal that the radar transceiver 260 can receiver and process to determine tag identification information for marker or markers which include such an RFID-MMID tag.

One or more estimated locations can be determined based on the return signals and a map of the marker locations (stage 715). One or more estimated locations of the navigation, and thus, the vehicle 110, can be estimated. The radar transceiver 260 and the lidar transceiver 265 can be configured to determine time-of-flight (TOF) information for the return signals. The time-of-flight information indicates how much time elapsed between the first signal being transmitted and the return signal(s) being received by the radar transceiver 260 and/or the lidar transceiver 265. The radar transceiver 260 and the lidar transceiver 265 can use the TOF information to determine how far away the vehicle 110 is from each of the markers 105 and/or markers 115 for which a return signal was received. Estimated locations can be selected for which the time-of-flight information for reflected and/or backscatter signals received at such a location approximately matches the actual time-of-flight information observed by the navigation unit 270. The navigation unit 270 can be configured to select estimated locations for which the observed time-of-flight information matches expected time-of-flight information based on the position of the markers 105 and/or markers 115 for which a return signal was received. The navigation unit 270 can be configured to determine that a “match” occurs where the observed values and the expected values differ by no more than a predetermined threshold value. The radar transceiver 260 can also be configured to decode tag identification information received from RFID-MMID tags disposed on any of the markers 105 and/or markers 115. As discussed above, the RFID-MMID tags can be configured to generate a modulated backscatter signal that the radar receiver 260 can include tag identification information, such as a unique tag identifier and/or geographical coordinates of the marker on which the tag is disposed. The navigation unit 260 can use the TOF information and any tag identification information that is available to determined estimated locations for the vehicle 110. The markers 105 and/or markers 115 may, in some implementations, be spaced apart in a predetermined pattern that can be notated into marker map information included in the map data 225. The navigation unit 270 can use the TOF information to eliminate location hypotheses in which the spacing pattern of markers does not align with the TOF information. In some implementations, the markers 105 and/or markers 115 can include color coded reflectors, and the computing system 200 of the vehicle 110 can be configured to include a camera or other optical sensor that is configured to detect the color coding of the reflectors. The markers 105 and/or markers 115 may include one or more reflectors of a particular color and the colors may be distributed on the markers 105 and/or markers 115 in a particular pattern. The pattern information can be included in the marker map information included in the map data 225. The markers may be coded using both unequal spacing and color coded reflectors in some implementations. The navigation unit 270 can use the TOF information to eliminate location hypotheses in which the color pattern of markers does not align with the TOF information.

The navigation unit 270 can also eliminate hypotheses that do not fall on a road included in the road map information (or that fall outside of navigable areas identified in map information for implementations for navigating an indoor and/or outdoor venue). The navigation unit 270 can be configured to compare the one or more estimated locations to map information to identify and eliminate any estimated locations that would place the vehicle 110 off of a road identified in the map information. Comparing the estimated locations to the map information can be used to refine the location of the vehicle by eliminating estimated locations that are not possible based on the layout of the roads or the navigable regions of an indoor or outdoor space. An example of such a technique is discussed below with respect to FIG. 7B.

FIG. 7B is a flow diagram of a process for navigation. The vehicle may be an autonomous or semi-autonomous vehicle (which is used to illustrate this particular example implementation) or other types of autonomous or semi-autonomous devices. The process illustrated in FIG. 7B can be implemented by the navigational and driving control systems of the vehicle 110 illustrated in FIG. 1. The computing device 200 of FIG. 2 can provide the means for implementing the navigational and driving control systems of the vehicle 110 and for implementing the process illustrated in FIG. 7B. The process illustrated in FIG. 7B can provide additional stages to the process illustrated in FIG. 7A or can be used to implement at least in part stage 715 by eliminating estimated locations of the vehicle that do not correspond with a known road included in road map information accessible by the navigation unit 270.

A refined location of the vehicle can be determined by comparing the one or more estimated locations to road map information, to venue map information, and/or other map information that can be used to eliminate estimated locations that are outside of a navigable area (stage 720). The one or more estimated locations of the vehicle 110 can be determined based on the return signals and/or backscatter signals received from markers 105 and/or markers 115 and on marker map information as discussed above. The navigation unit 270 of the computing device 200 can include road map information for a geographical area in which the vehicle 110 is traveling. The map data 225 may be stored into a memory 215 of the computing device 200 by the vehicle manufacturer or may be downloaded or otherwise installed by a user of the vehicle 110. The navigation unit 270 can be configured to periodically check for updates to the map data 225 by contacting a remote map content server using the network interface 205. The navigation unit 270 can be configured to compare the estimated locations of the vehicle that were determined in the preceding stage 715 to identify estimated locations that fall off of roadways or other drivable areas designated on the maps. As discussed above, the navigation unit 270 may determine that the vehicle 110 may possibly be located at more than one location based on the reflected and/or backscatter signals received by the radar transceiver 260 and/or the lidar transceiver 265. However, estimated locations that do not fall on a road or within another navigable space identified in the map information can be eliminated to arrive at a refined location for the vehicle 110. If more than one estimated location falls on a road or other navigable space according to the map data 225, the navigation unit 270 can use additional information to attempt to eliminate one or more of the estimated locations that fall onto the roads to come to determination of the refined location for the vehicle 110. The navigation unit 270 can also be configured to monitor reflected and/or backscatter signals received from markers once the location of the vehicle 110 has been determined to identify missing, malfunctioning, or damaged markers according to the techniques discussed above and can be configured to send error reports to a navigation server regarding the missing, malfunctioning, or damaged markers.

FIG. 8 is a flow diagram of a process for navigation. The vehicle may be an autonomous or semi-autonomous vehicle (which is used to illustrate this particular example implementation) or other types of autonomous or semi-autonomous devices. The process illustrated in FIG. 8 can implement, at least in part, stage 710 of the process illustrated in FIG. 7. The process illustrated in FIG. 8 can be implemented by the navigational and driving control systems of the vehicle 110 illustrated in FIG. 1. The computing device 200 of FIG. 2 can provide the means for implementing the navigational and driving control systems of the vehicle 110 and for implementing the process illustrated in FIG. 8.

First reflected signal(s) are received from a first subset of the markers (stage 805). As discussed above, the radar transceiver 260 and/or the lidar transceiver 265 can be configured to transmit a first signal that can be reflected by markers that are proximate to the vehicle 110. The first subset of markers may be disposed along the road such that the markers are reflectors disposed thereon are configured to reflect radar and/or lidar signals back to vehicles, such as vehicle 110, that are traveling in a particular direction of travel along the road. Such directionality could be used to eliminate location hypotheses that would have placed the vehicle on a portion of the road traveling in an opposite direction. Furthermore, the radar and lidar signals have a range that is limited by atmospheric conditions, such as rain, snow, fog, smoke, and dust, and the relative position of the vehicle to the markers.

FIG. 9 is a flow diagram of a process for navigation. The vehicle may be an autonomous or semi-autonomous vehicle. The process illustrated in FIG. 9 can implement, at least in part, stage 710 of the process illustrated in FIG. 7 or stage 805 of the process illustrated in FIG. 8. The process illustrated in FIG. 9 can be implemented by the navigational and driving control systems of the vehicle 110 illustrated in FIG. 1. The computing device 200 of FIG. 2 can provide the means for implementing the navigational and driving control systems of the vehicle 110 and for implementing the process illustrated in FIG. 9.

A millimeter wave backscatter signal can be received from a marker (stage 905). As discussed above, an RFID-MMID tag can be disposed on at least a portion of the markers 105 and/or the markers 115. The RFID-MMID tags can be similar to those discussed above with respect the preceding figures. The RFID-MMID tags can be configured to respond to a UHF signal transmitted by a UHF transmitter 345 of the navigation system of the vehicle 110 or by the radar signals transmitted by the radar transceiver 260. The RFID-MMID tags can be configured to generate a millimeter wave backscatter signal that can be detected to the modified radar receiver of the navigation system of the vehicle 110, such as the example radar transceiver illustrated in FIG. 3.

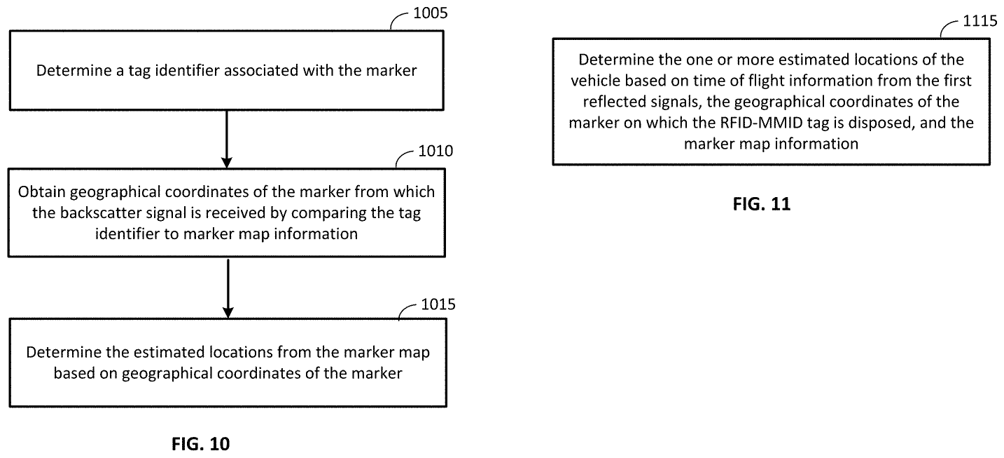

FIG. 10 is a flow diagram of a process for navigation. The vehicle may be an autonomous or semi-autonomous vehicle (which is used to illustrate this particular example implementation) or other types of autonomous or semi-autonomous devices. The process illustrated in FIG. 10 can implement, at least in part, stage 715 of the process illustrated in FIG. 7. The process illustrated in FIG. 10 can be implemented by the navigational and driving control systems of the vehicle 110 illustrated in FIG. 1. The computing device 200 of FIG. 2 can provide the means for implementing the navigational and driving control systems of the vehicle 110 and for implementing the process illustrated in FIG. 10.

A tag identifier associated with the marker from which a backscatter signal is received can be determined (stage 1005). As discussed above, at least some of the markers 105 and/or markers 115 can include a RFID-MMID tag that can be activated either by the UHF transmitter 345 of the navigation system of the vehicle 110 or by the radar signals transmitted by the radar transceiver 260. The RFID-MMID tag can be powered by the UHF or radar signal received from the vehicle 110 or may be powered by a power source but activated by the receipt of the UHF or radar signal. The RFID-MMID tag can generate a modulated backscatter signal that includes tag identification information, such as a unique tag identifier and/or geographical location of the marker on which tag is disposed. The backscatter signal transmitted by the RFID-MMID tag is transmitted within the frequency range supported by the radar transceiver 265. The radar transceiver 265 is configured to decode the modulated backscatter signal in order to extract the tag identifier information.

Geographical coordinates of the marker from which the backscatter signal is received can be obtained by comparing the tag identifier to marker map information (stage 1010). The marker map information of the map data 225 can include information that associates the tag identifiers with the geographical locations of the markers on which the RFID-MMID tags are disposed. The navigation unit 270 can be configured to receive the tag identification information from the radar transceiver 260 and to compare the tag identification information to the map information 225 to determine the location of the markers for which backscatter signals were received. As discussed above, the tag identification information may also include geographical coordinates of the markers on which the RFID-MMID tag is disposed. In some implementations, the navigation unit 270 can be configured to access the marker map information and/or the road map information as a database stored in a memory of the navigation system of the vehicle 110 in order to obtain the geographical coordinates of a marker. In such implementations, the navigation unit 270 would not need to look up the tag identifier in the map information. However, the navigation unit 270 may be configured to verify the integrity of the tag identification information by comparing the tag identifier and geographical coordinates extracted from the backscatter signal by the radar transceiver 260 with the tag identifiers and geographical coordinate information included in the map data 225. In some implementations, the tag identification information can also include tag identifiers and geographical coordinates of RFID-MMID tags disposed on one or more markers proximate to the marker on which a particular RFID-MMID tag is disposed. The navigation system of the vehicle can use this information to determine whether the vehicle is moving along an expected route by determining whether observed RFID-MMID tags match those expected based on the marker map data and the tag identification information for neighboring markers obtained from each marker. In some implementations, the RFID-MMID tags may not have unique identifiers, and the navigation unit 270 can be configured to obtain additional information to determine the geographical location of a marker. For example, the navigation unit 270 can be configured to obtain a coarse location of the vehicle based on signals received from wireless transmitters proximate to the vehicle, such as but not limited to WWAN base stations and WLAN access points. The wireless transmitters may transmit an identifier that the navigation unit 270 can look up in transmitter geographical location information to determine a coarse location of the vehicle. The navigation unit 270 can be configured to determine how far the vehicle is from such wireless transmitters based on the time-of-flight information for such signals (where the signals include information as to when they were transmitted or such information can be looked up by the navigation unit 270). The navigation unit 270 can also be configured to determine a coarse location of the vehicle 110 based on one or more GNSS satellite signals. The GNSS receiver may not have acquired enough signals to determine an exact fix for the location of the vehicle 110, but the navigation unit 270 can use the GNSS satellite signal information to determine a rough estimate for the vehicle. The rough estimate information from one or more sources can also be combined to further refine the coarse location of the vehicle by reducing the size of the geographical area in which the vehicle 110 may be located and/or by eliminating areas in which the vehicle could not be based on the wireless signals received, GNSS signals received, and other information collected by the navigation unit 270 of the vehicle 110.

In implementations where the RFID tags do not include a unique identifier, the navigation unit 270 can be configured to determine a location of a marker based on the identifier of the marker and the identifier of one or more markers proximate to the marker. The marker and the markers proximate to the marker may have a cluster of identifiers that is unique to a particular geographical area. The navigation unit 270 can use these clusters to eliminate markers having the same identifier but not having neighbors with the same identifiers as those observed for a particular marker for which the navigation unit 270 is attempting to determine a location.

Estimated locations of the vehicle can be determined based on the geographical coordinates of the marker (stage 1015). The navigation unit 270 can be configured to access marker map information and to identify the location of the marker on which the RFID-MMID tag is disposed based on these geographical coordinates. The navigation unit 270 can also access the locations of markers proximate to the marker matching the geographical coordinates. The navigation unit 270 can be configured to use the time-of-flight information for reflected signals and the position of the markers proximate to the marker matching the geographical coordinates to determine estimated locations where the vehicle 110 may be located. The navigation unit 270 can be configured to select estimated locations for which the observed time-of-flight information matches expected time-of-flight information based on the position of the markers 105 and/or markers 115 for which a return signal was received. The navigation unit 270 can be configured to determine that a “match” occurs where the observed values and the expected values differ by no more than a predetermined threshold value. The navigation unit 270 can be configured to examine geometric groupings or subsets of markers to determine whether a pattern of reflected signals and/or backscatter signals received by the navigation unit 270 would be possible given the layout of the markers relative to one another and to eliminate potential locations for the vehicle proximate to such groupings or subsets of markers where the expected time-of-flight information would be different from the observed time-of-flight information for the reflected and/or backscatter signals. The navigation unit 270 can be further configured to access road map information and to eliminate any of the estimated locations which would place the vehicle 110 off of a road.

FIG. 11 is a flow diagram of a process for navigation. The vehicle may be an autonomous or semi-autonomous vehicle (which is used to illustrate this particular example implementation) or other types of autonomous or semi-autonomous devices. The process illustrated in FIG. 11 can implement, at least in part, stage 715 of the process illustrated in FIG. 7. The process illustrated in FIG. 11 can be implemented by the navigational and driving control systems of the vehicle 110 illustrated in FIG. 1. The computing device 200 of FIG. 2 can provide the means for implementing the navigational and driving control systems of the vehicle 110 and for implementing the process illustrated in FIG. 11.

One or more estimated locations of the vehicle can be determined based on time of flight information from the first reflected signals, the geographical coordinates of the marker on which the RFID-MMID tag is disposed, and the marker map information (stage 1105). The navigation unit 270 can use the geographical location information obtained from the one or more RFID-MMID tags disposed on the nearby markers either directly from the backscatter signal or by looking up the tag identifiers in the map data 225. If the geographical coordinates of the markers that include RFID-MMID tags of more than three markers proximate to the vehicle 110 can be obtained, the navigation unit 270 may determine an estimated location of the vehicle 110 using triangulation. Where there are less than known marker geographical locations available, the navigation unit 270 can be configured to determine the estimated locations based on the TOF information of the reflected signals received back at the radar transceiver 260 and/or the lidar transceiver 265 and the known geographical locations of markers that included RFID-MMID tags (if any) can be compared to the marker map information of the map data 225 to identify locations where the vehicle 110 may be located. As discussed above, the markers may be disposed along the roadway such that the markers are spaced apart from one another in a predetermined pattern. Spacing the markers along the roadway in a predetermined pattern affects the TOF of reflects signals. The TOF information obtained by the navigation unit 270 can be used to deduce a geometrical relationship between the current position of the vehicle 110 and the markers. By comparing these deduced geometrical relationships to the patterns of markers included in the map data 225, the navigation unit 270 can determine one or more estimated locations where the vehicle 110 may be located. The estimated location can be refined by comparing the estimated locations to road map information to eliminate estimated locations where the vehicle 110 is located off of a road.

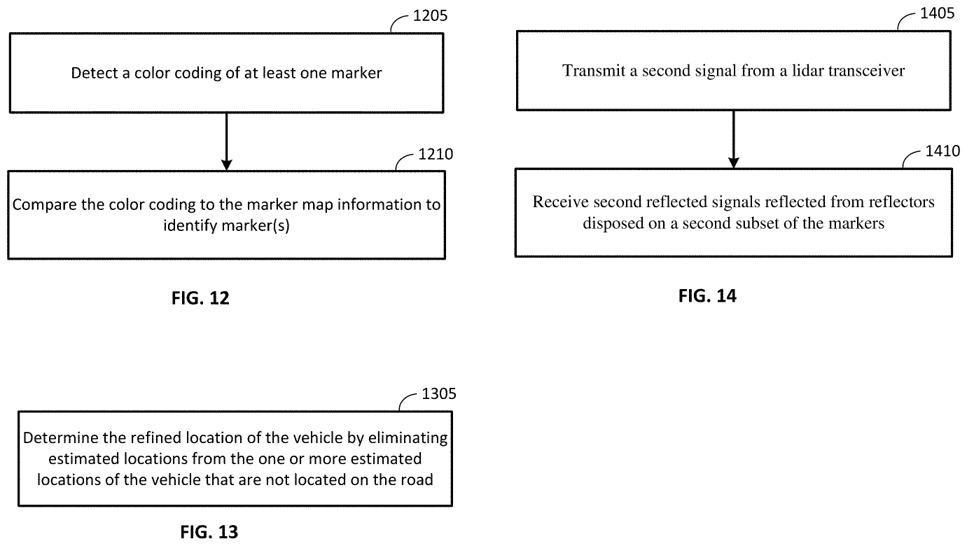

FIG. 12 is a flow diagram of a process for navigation. The vehicle may be an autonomous or semi-autonomous vehicle (which is used to illustrate this particular example implementation) or other types of autonomous or semi-autonomous devices. The process illustrated in FIG. 12 can implement, at least in part, stage 715 of the process illustrated in FIG. 7. The process illustrated in FIG. 12 can be implemented by the navigational and driving control systems of the vehicle 110 illustrated in FIG. 1. The computing device 200 of FIG. 2 can provide the means for implementing the navigational and driving control systems of the vehicle 110 and for implementing the process illustrated in FIG. 12.

Color coding of at least one marker (stage 1205). The navigation system 200 of the vehicle 110 can include a camera or other optical sensor configured to detect the color of reflectors disposed on one or more of the markers 105 and/or markers 115 proximate to the vehicle 110. As discussed above, at least a subset of the markers 105 and/or markers 115 can include at least one color coded reflector.

Compare the color coding to market map information to identify marker(s) (1210). Light reflected by the at least one reflector can be detected by the camera or other optical sensor, and the navigation unit 270 can be configured to compare the pattern of colors identified to the marker map information of the map data 225 to identify markers or groups or markers that are coded with similar pattern. The navigation unit 270 can use this information can be used to determine one or more estimated locations of the vehicle 110. The navigation unit 270 can use the color coding information in combination with reflected radar signals, reflected lidar signals, backscatter signals, or a combination thereof to determine estimated locations of the vehicle 110.

FIG. 13 is a flow diagram of a process for navigation. The vehicle may be an autonomous or semi-autonomous vehicle (which is used to illustrate this particular example implementation) or other types of autonomous or semi-autonomous devices. The process illustrated in FIG. 13 can implement, at least in part, stage 720 of the process illustrated in FIG. 7. The process illustrated in FIG. 13 can be implemented by the navigational and driving control systems of the vehicle 110 illustrated in FIG. 1. The computing device 200 of FIG. 2 can provide the means for implementing the navigational and driving control systems of the vehicle 110 and for implementing the process illustrated in FIG. 13.

The refined location of the vehicle can be determined by eliminating estimated locations from the one or more estimated locations of the vehicle that are not located on the road (stage 1305). The estimated locations of the vehicle 110 determined by the navigation unit 270 may include one or more locations that are not possible or should not be possible, because such locations would place the vehicle off of a roadway. The navigation unit 270 can be configured to compare these estimated locations with road map data included in the map date 225. The navigation unit 270 can be configured to discard estimated locations that do not place the vehicle on a road identified in the road maps. The navigation unit 270 can assume that the vehicle should be navigating on a known road.

FIG. 14 is a flow diagram of a process for navigation. The vehicle may be an autonomous or semi-autonomous vehicle (which is used to illustrate this particular example implementation) or other types of autonomous or semi-autonomous devices. The process illustrated in FIG. 14 can implement, at least in part, additional or alternative stages of the process illustrated in FIG. 7. The process illustrated in FIG. 14 can be implemented by the navigational and driving control systems of the vehicle 110 illustrated in FIG. 1. The computing device 200 of FIG. 2 can provide the means for implementing the navigational and driving control systems of the vehicle 110 and for implementing the process illustrated in FIG. 14.

A second signal can be transmitted by a lidar transceiver (stage 1405). The lidar transceiver 265 of the navigation system 200 of the vehicle 110 can be configured to transmit a lidar signal. In some implementations, the navigation system 200 may include both a radar transceiver 260 and a lidar transceiver 265. The navigation system 200 may include both the radar transceiver 260 and the lidar transceiver 265, because different localities may implement different types of markers for vehicles and the navigation system 200 may encounter markers for lidar and/or radar based navigation. More than one vehicle may be and is likely to be on the road at the same time. Accordingly, the lidar transceiver 265 can be configured to utilize a unique (or relatively unique) signal pulse pattern that the lidar transceiver 265 can identify in the reflected signals to reduce interference from other vehicles using similar techniques for navigating the road proximate to the location of the vehicle 110.

Second reflected signal(s) can be received from reflectors disposed on a second subset of the markers (stage 1410). As discussed above, the lidar transceiver 265 can be configured to transmit a signal that can be reflected by markers that are proximate to the vehicle 110. The secpmd subset of markers may be disposed along the road such that the markers are reflectors disposed thereon are configured to reflect lidar signals back to vehicles, such as vehicle 110, that are traveling in a particular direction of travel along the road. Such directionality could be used to eliminate location hypotheses that would have placed the vehicle on a portion of the road traveling in an opposite direction. Furthermore, the radar and lidar signals have a range that is limited by atmospheric conditions, such as rain, snow, fog, smoke, and dust, and the relative position of the vehicle to the markers.

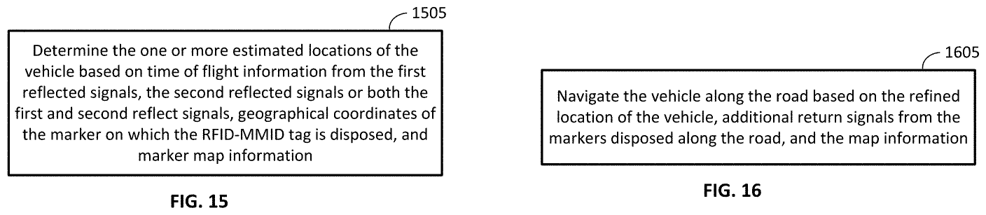

FIG. 15 is a flow diagram of a process for navigation. The vehicle may be an autonomous or semi-autonomous vehicle (which is used to illustrate this particular example implementation) or other types of autonomous or semi-autonomous devices. The process illustrated in FIG. 15 can implement, at least in part, stage 715 of the process illustrated in FIG. 7. The process illustrated in FIG. 15 can be implemented by the navigational and driving control systems of the vehicle 110 illustrated in FIG. 1. The computing device 200 of FIG. 2 can provide the means for implementing the navigational and driving control systems of the vehicle 110 and for implementing the process illustrated in FIG. 15.

One or more estimated locations of the vehicle can be determined based on time of flight information from the first reflected signals, the second reflected signals or both the first and second reflected signals, geographical coordinates of the marker on which the RFID-MMID tag is disposed, and marker map information (stage 1105). The navigation unit 270 can use the geographical location information obtained from the one or more RFID-MMID tags disposed on the nearby markers either directly from the backscatter signal or by looking up the tag identifiers in the map data 225. If the geographical coordinates of the markers that include RFID-MMID tags of more than three markers proximate to the vehicle 110 can be obtained, the navigation unit 270 may determine an estimated location of the vehicle 110 using triangulation. Where there are less than known marker geographical locations available, the navigation unit 270 can be configured to determine the estimated locations based on the TOF information of the reflected signals received back at the radar transceiver 260 and/or the lidar transceiver 265 and the known geographical locations of markers that included RFID-MMID tags (if any) can be compared to the marker map information of the map data 225 to identify locations where the vehicle 110 may be located. As discussed above, the markers may be disposed along the roadway such that the markers are spaced apart from one another in a predetermined pattern. Spacing the markers along the roadway in a predetermined pattern affects the TOF of reflects signals. The TOF information obtained by the navigation unit 270 can be used to deduce a geometrical relationship between the current position of the vehicle 110 and the markers. By comparing these deduced geometrical relationships to the patterns of markers included in the map data 225, the navigation unit 270 can determine one or more estimated locations where the vehicle 110 may be located. The estimated location can be refined by comparing the estimated locations to road map information to eliminate estimated locations where the vehicle 110 is located off of a road.

FIG. 16 is a flow diagram of a process for navigation. The vehicle may be an autonomous or semi-autonomous vehicle (which is used to illustrate this particular example implementation) or other types of autonomous or semi-autonomous devices. The process illustrated in FIG. 16 can implement, at least in part, additional or alternative stages of the process illustrated in FIG. 7B. The process illustrated in FIG. 16 can be implemented by the navigational and driving control systems of the vehicle 110 illustrated in FIG. 1. The computing device 200 of FIG. 2 can provide the means for implementing the navigational and driving control systems of the vehicle 110 and for implementing the process illustrated in FIG. 16.

The vehicle can be navigated along the road based on the refined location of the vehicle, additional return signals from markers disposed along the road, and the road map information (stage 1605). The navigation unit 270 can be configured to generate signals to the vehicle control unit 275 to control the operation of the vehicle 110 and to cause the vehicle 110 to drive along the road to a predetermined destination. The navigation unit 270 can be configured to transmit additional signals and to receive additional reflected radar and/or lidar signals, and/or backscatter signals and to continue to determine estimated and refined locations of the vehicle based on these signals and the marker map and road map data.

If implemented in-part by hardware or firmware along with software, the functions can be stored as one or more instructions or code on a computer-readable medium. Examples include computer-readable media encoded with a data structure and computer-readable media encoded with a computer program. Computer-readable media includes physical computer storage media. A storage medium can be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and can be based on one or more items and/or conditions in addition to the stated item or condition.

What is claimed is:

1. A method for operating a navigation system, the method comprising:
transmitting a first signal, via an ultra-high frequency (UHF) band, to one or more markers;
receiving return signals, at a radar transceiver via a second frequency range different from the UHF band, from the one or more markers; and
determining one or more estimated locations of the navigation system based on the return signals.

2. The method of claim 1, wherein the return signals indicate location information for the one or more markers.

3. The method of claim 1, wherein the second frequency range is a millimeter band.

4. The method of claim 2, wherein the return signals indicate location information for the one or more markers comprises one or more tag identifiers associated with the one or more markers.

5. The method of claim 1, wherein determining the one or more estimated locations of the navigation system comprises:
determining the one or more estimated locations of the navigation system based on time of flight information of the return signals.

6. The method of claim 4, wherein determining the one or more estimated locations of the navigation system comprises:
obtaining geographical coordinates of the one or more markers based on the return signals;
determining the one or more estimated locations of the navigation system based on the geographical coordinates of the one or more markers and the return signals.

7. The method of claim 6, wherein the one or more estimate locations of the navigation system is further based on predetermined pattern of the one or more markers.

8. The method of claim 1, the method further comprising:
detecting a color coding of at least one marker;
comparing the color coding to map information;
wherein the determining one or more estimated locations of the navigation system is further based on the comparison of the color coding to the map information.

9. The method of claim 4, identifying at least one marker from the one or more markers that are not located at an expected location;
transmitting a report indicating an updated location of a marker from the one or more markers or an absence of a marker.

10. The method of claim 4, further comprising:
determining a refined location of the navigation system by eliminating estimated locations from the one or more estimated locations of the navigation system that are not located on a road.

11. The method of claim 2, further comprising:
transmitting a second signal from a lidar transceiver; and
receiving second reflected signals reflected from reflectors disposed on a second subset of markers, the second reflected signals being reflections of the second signal.

12. The method of claim 11, wherein determining the one or more estimated locations of the navigation system comprises:
determining the one or more estimated locations of the navigation system based on the location information of the markers and time of flight information of the return signals, time of flight information of the second reflected signals, or time of flight information of both.

13. The method of claim 1, further comprising:
navigating the navigation system along a road based on the one or more estimated locations of the navigation system and road map information.

14. A navigation system comprising:
means for transmitting a first signal, via an ultra-high frequency (UHF) band, to one or more markers;
means for receiving return signals, at a radar transceiver via a second frequency range different from the UHF band, from the one or more markers; and
means for determining one or more estimated locations of the navigation system based on the return signals.

15. The navigation system of claim 14, wherein the return signals indicate location information for the one or more markers.

16. The navigation system of claim 14, wherein the second frequency range is a millimeter band.

17. The navigation system of claim 15, wherein the return signals indicate location information for the at least one marker from the one or more markers comprises one or more tag identifiers associated with the one or more markers.

18. The navigation system of claim 14, wherein the means for determining the one or more estimated locations of the navigation system comprises:
means for determining the one or more estimated locations of the navigation system based on time of flight information of the return signals.

19. The navigation system of claim 18, wherein the means for determining the one or more estimated locations of the navigation system comprises:
means for obtaining geographical coordinates of the one or more markers based on the return signals;
means for determining the one or more estimated locations of the navigation system based on the geographical coordinates of the one or more markers and the return signals.

20. A navigation system comprising:
a radar transceiver;
an ultra-high frequency (UHF) transmitter configured to transmit a first signal, via an UHF band, to one or more markers;
a memory; and
a processor communicatively coupled to the memory, the UHF transmitter and the radar transceiver, the processor configured to:
receive return signals, at the radar transceiver via a second frequency range different from the UHF band, from the one or more markers; and
determine one or more estimated locations of the navigation system based on the return signals.

21. The navigation system of claim 20, wherein the return signals indicate location information for the one or more markers.

22. The navigation system of claim 20, wherein the second frequency range is a millimeter band.

23. The navigation system of claim 21, wherein the return signals indicate location information for the at least one marker from the one or more markers comprises one or more tag identifiers associated with the one or more markers.

24. The navigation system of claim 20, wherein the processor is configured to determine the one or more estimated locations of the navigation system based on time of flight information of the return signals.

25. The navigation system of claim 23, wherein the processor is configured to determine the one or more estimated locations of the navigation system comprises the processor is configured to:
obtain geographical coordinates of the one or more markers based on the return signals;
determine the one or more estimated locations of the navigation system based on the geographical coordinates of the one or more markers and the return signals.

26. The navigation system of claim 24, the processor is further configured to:
detect a color coding of at least one marker;
compare the color coding to map information;
wherein the process is configured to determine one or more estimated locations of the navigation system is further based on the comparison of the color coding to the map information.

27. A non-transitory, computer-readable medium, having stored thereon computer-readable instructions for operating a navigation system, comprising instructions configured to cause the navigation system to:
transmit a first signal, via an ultra-high frequency band (UHF) band, to one or more markers;
receive, at a radar transceiver via a second frequency range different from the UHF band, return signals from the one or more markers;
determine one or more estimated locations of the navigation system based on the return signals.

28. The non-transitory, computer-readable medium of claim 27, wherein the return signals indicate location information for the one or more markers.

29. The non-transitory, computer-readable medium of claim 27, wherein the second frequency range is a millimeter band.

30. The non-transitory, computer-readable medium of claim 28, wherein determine the one or more estimated locations of the navigation system comprises:
obtain geographical coordinates of the one or more markers based on the return signals; and
determine the estimated locations from the marker map based the geographical coordinates of the one or more markers and the return signals.
